(19) United States
(12) Patent Application Publication
(10) Pub. No.: US 2020/0257422 A1
(43) Pub. Date: Aug. 13, 2020

(54) OPERATION DEVICE, AND OPERATION METHOD AND OPERATION PROGRAM THEREOF

(71) Applicant: FUJIFILM Corporation, Tokyo (JP)

(72) Inventors: Tomokazu NAKAMURA, Saitama-shi (JP); Yoshikuni NISHIURA, Saitama-shi (JP); Takeharu OMATA, Saitama-shi (JP); Nanae SAKUMA, Saitama-shi (JP)

(73) Assignee: FUJIFILM Corporation, Tokyo (JP)

(21) Appl. No.: 16/861,938

(22) Filed: Apr. 29, 2020

Related U.S. Application Data
(63) Continuation of application No. PCT/JP2018/039770, filed on Oct. 25, 2018.

(30) Foreign Application Priority Data
Oct. 31, 2017 (JP) 2017-210044

(51) Int. Cl. G06F 3/0484; H04N 5/232

(52) U.S. Cl. CPC G06F 3/0484; H04N 5/23216

(57) ABSTRACT

First and second reception units receive a setting instruction for a first correspondence relationship which is a correspondence relationship between a direction of a first operation performed on a touch-type operation unit and a movement direction in which a list image moves with respect to a screen in response to the first operation, and a second correspondence relationship which is a correspondence relationship between a direction of a second operation performed on a direction instruction key and a movement direction in which the list image moves with respect to the screen in response to the second operation. An information management unit sets the first correspondence relationship and the second correspondence relationship. A command output unit decides the movement direction of the list image with respect to the screen based on the first correspondence relationship or the second correspondence relationship in a case where the first operation or the second operation is performed. A display control unit moves the list image in the decided movement direction.

### CROSS-REFERENCE TO RELATED APPLICATIONS

This application is a Continuation of PCT International Application No. PCT/JP2018/039770 filed on 25 Oct. 2018, which claims priority under 35 U.S.C § 119(a) to Japanese Patent Application No. 2017-210044 filed on 31 Oct. 2017. The above application is hereby expressly incorporated by reference, in its entirety, into the present application.

### BACKGROUND OF THE INVENTION

### 1. Field of the Invention

The present invention relates to an operation device, and an operation method and an operation program thereof.

### 2. Description of the Related Art

An operation device equipped with a touch panel display has been widely used. The touch panel display is composed of a display unit such as a liquid crystal display and a transparent touch-type operation unit (also referred to as a touch pad) that is disposed on a screen of the display unit in an overlapped manner. The touch panel display displays an operation target on the screen of the display unit and recognizes a gesture operation (hereinafter a first operation) by a finger of a user touching the touch-type operation unit.

The first operation includes, for example, a swipe operation and a flick operation. The swipe operation is an operation in which a finger is brought to touch the touch-type operation unit, is slowly moved in a certain direction, and then is released from the touch-type operation unit. The flick operation is an operation in which a finger is brought to touch the touch-type operation unit and is quickly swept in a certain direction to be released from the touch-type operation unit.

In the operation device equipped with the touch panel display, a list image or a cursor is displayed on the screen of the display unit as the operation target. The list image is an image in which a plurality of selection candidates are arranged, and the cursor is for selecting one of the plurality of selection candidates arranged in the list image. The list image or the cursor is moved with respect to the screen in response to the above swipe operation or flick operation.

There is an operation device equipped with the touch panel display comprising a mechanical-type operation unit, in addition to the touch-type operation unit, to compensate for an inconvenient operation in the touch-type operation unit, for example, as in a digital camera described in JP2012-037974A (corresponding to US2012/0032988A1). The mechanical-type operation unit is an operation unit having a mechanical structure such as a direction instruction key and a rotary wheel and having a shape and operation feeling that can be tactilely perceived such as an uneven shape.

In the digital camera described in JP2012-037974A, a list image in which a plurality of captured images are arranged is displayed on a screen of a display unit as an operation target. Then, a movement in an up-down direction (scroll) of the list image with respect to the screen is instructed by any one of the following three methods. First, a first method is to operate the direction instruction key upward to move the list image downward with respect to the screen and conversely, to operate the direction instruction key downward to move the list image upward with respect to the screen. In a case where the list image is moved downward with respect to the screen, a portion of the list image that has not been displayed at the upper part of the screen is displayed on the screen. On the contrary, in a case where the list image is moved upward with respect to the screen, a portion of the list image that has not been displayed at the lower part of the screen is displayed on the screen.

A second method of performing the instruction that the list image moves in the up-down direction with respect to the screen is to operate the rotary wheel clockwise to move the list image upward with respect to the screen and conversely, to operate the rotary wheel counterclockwise to move the list image downward with respect to the screen. A third method is an upward swipe operation or flick operation on the touch-type operation unit to move the list image upward with respect to the screen and conversely, a downward swipe operation or flick operation on the touch-type operation unit to move the list image downward with respect to the screen. Hereinafter, the operation performed on the mechanical-type operation unit such as the direction instruction key or the rotary wheel is referred to as a second operation.

### SUMMARY OF THE INVENTION

As in the digital camera described in JP2012-037974A, the directions of the first and second operations and the movement direction of the operation target (list image in JP2012-037974A) with respect to the screen in response to each operation are set in advance and fixed in the operation device. Therefore, a user who feels uncomfortable in an initial operation with the fixed setting is required to perform the operation while dragging the uncomfortable feeling until the user is accustomed to the operation.

For example, it is assumed that there is a user who has become accustomed to an operation device, in which the setting of the directions of the first and second operations matches the setting of the movement direction of the operation target with the touch-type operation unit and the direction instruction key. It is considered a case where the user operates an operation device, in which the setting of the directions of the first and second operations does not match the setting of the movement direction of the operation target with the touch-type operation unit and the direction instruction key, as in the digital camera described in JP2012-037974A. In this case, the user is confused due to the different setting from the accustomed operation device and may think for a moment before the operation or make an operation error.

An object of the present invention is to provide an operation device that can be operated by a user without feeling uncomfortable, and an operation method and an operation program thereof.

In order to solve the above problems, an operation device according to the present invention comprises a touch panel display composed of a display unit having a screen for displaying an operation target and a transparent touch-type operation unit disposed on the screen in an overlapped manner, a mechanical-type operation unit provided separately from the touch-type operation unit and having a mechanical structure, a reception unit that receives a setting instruction for a first correspondence relationship which is a correspondence relationship between a direction of a first operation performed on the touch-type operation unit and a movement direction in which the operation target moves with respect to the screen in response to the first operation, and a second correspondence relationship which is a correspondence relationship between a direction of a second operation performed on the mechanical-type operation unit and a movement direction in which the operation target moves with respect to the screen in response to the second operation, a setting unit that sets the first correspondence relationship and the second correspondence relationship in response to the setting instruction, a deciding unit that decides the movement direction of the operation target with respect to the screen based on the first correspondence relationship or the second correspondence relationship set by the setting unit in a case where the first operation or the second operation is performed, and a display control unit that moves the operation target in the movement direction decided by the deciding unit.

It is preferable that the setting unit sets the first correspondence relationship and the second correspondence relationship for each operation target.

It is preferable that the operation target includes at least one of a list image in which a plurality of selection candidates are arranged or a cursor for selecting one of the plurality of selection candidates arranged in the list image.

It is preferable that the cursor becomes the operation target in a case where the cursor moves within a range of the screen, and the operation target is changed to the list image in a case where the cursor is moved to an end of the screen and the first operation or the second operation is further performed in a direction where the cursor is moved out of the range of the screen.

It is preferable that a list image in which a plurality of selection candidates are arranged on a fixed background image is displayed as the operation target on the screen, and the operation device further comprises a command output unit that converts the first operation on a portion corresponding to the selection candidate into a command to move the selection candidate in a direction of the first operation, converts the first operation on a portion corresponding to the background image into a command to move the list image based on the first correspondence relationship, and outputs the commands to the display control unit.

It is preferable that the operation device further comprises a timer unit that measures an elapsed time from a previous first operation or a previous second operation, and the display control unit executes the movement of the operation target based on a correspondence relationship related to a current operation out of the first correspondence relationship and the second correspondence relationship in a case where the elapsed time is equal to or larger than a preset threshold value, and in a case where the elapsed time is less than the threshold value and both a previous operation and the current operation are the first operation or the second operation, and executes the movement of the operation target based on a correspondence relationship related to the previous operation out of the first correspondence relationship and the second correspondence relationship in a case where the elapsed time is less than the threshold value and the previous operation is the first operation and the current operation is the second operation or the previous operation is the second operation and the current operation is the first operation.

It is preferable that the first operation includes at least one of a swipe operation in which a finger is brought to touch the touch-type operation unit, is slowly moved in a certain direction, and then is released from the touch-type operation unit, or a flick operation in which a finger is brought to touch the touch-type operation unit and is quickly swept in a certain direction to be released from the touch-type operation unit.

It is preferable that the mechanical-type operation unit is at least one of a direction instruction key operated in up, down, left, and right directions, or a rotary wheel rotationally operated clockwise and counterclockwise.

It is preferable that the operation device is used for an imaging device.

In an operation method of an operation device including a touch panel display composed of a display unit having a screen for displaying an operation target and a transparent touch-type operation unit disposed on the screen in an overlapped manner and a mechanical-type operation unit provided separately from the touch-type operation unit and having a mechanical structure, the operation method of the operation device comprises a reception step of receiving a setting instruction for a first correspondence relationship which is a correspondence relationship between a direction of a first operation performed on the touch-type operation unit and a movement direction in which the operation target moves with respect to the screen in response to the first operation, and a second correspondence relationship which is a correspondence relationship between a direction of a second operation performed on the mechanical-type operation unit and a movement direction in which the operation target moves with respect to the screen in response to the second operation, a setting step of setting the first correspondence relationship and the second correspondence relationship in response to the setting instruction, a deciding step of deciding the movement direction of the operation target with respect to the screen based on the first correspondence relationship or the second correspondence relationship set in the setting step in a case where the first operation or the second operation is performed, and a display control step of moving the operation target in the movement direction decided in the deciding step.

In an operation program of an operation device including a touch panel display composed of a display unit having a screen for displaying an operation target and a transparent touch-type operation unit disposed on the screen in an overlapped manner and a mechanical-type operation unit provided separately from the touch-type operation unit and having a mechanical structure, the operation program of the operation device causing a computer to execute a reception function of receiving a setting instruction for a first correspondence relationship which is a correspondence relationship between a direction of a first operation performed on the touch-type operation unit and a movement direction in which the operation target moves with respect to the screen in response to the first operation, and a second correspondence relationship which is a correspondence relationship between a direction of a second operation performed on the mechanical-type operation unit and a movement direction in which the operation target moves with respect to the screen in response to the second operation, a setting function of setting the first correspondence relationship and the second correspondence relationship in response to the setting instruction, a deciding function of deciding the movement direction of the operation target with respect to the screen based on the first correspondence relationship or the second correspondence relationship set by the setting function in a case where the first operation or the second operation is performed, and a display control function of moving the operation target in the movement direction decided by the deciding function.

In the present invention, the first correspondence relationship which is the correspondence relationship between the direction of the first operation performed on the touch-type operation unit and the movement direction in which the operation target moves with respect to the screen in response to the first operation, and the second correspondence relationship which is the correspondence relationship between the direction of the second operation performed on the mechanical-type operation unit and the movement direction in which the operation target moves with respect to the screen in response to the second operation are set in response to the setting instruction, and in a case where the first operation or the second operation is performed, the movement direction of the operation target with respect to the screen is decided based on the set first correspondence relationship or the second correspondence relationship and the operation target is moved in the decided movement direction. Therefore, it is possible to set the first correspondence relationship and the second correspondence relationship according to the preference of the user and move the operation target based on these correspondence relationships. Therefore, it is possible to provide an operation device that can be operated by a user without feeling uncomfortable, and an operation method and an operation program thereof.

### BRIEF DESCRIPTION OF THE DRAWINGS

FIG. 1 is a front external perspective view of a digital camera.

FIG. 2 is a rear external perspective view of the digital camera.

FIG. 3 is a schematic diagram of a touch panel display.

FIG. 4 is a diagram showing a state of a swipe operation or a flick operation.

FIG. 5 is a diagram showing a list image.

FIG. 6 is a diagram showing a setting image.

FIG. 7 is a block diagram of the digital camera.

FIG. 8 is a block diagram of a CPU of the digital camera.

FIG. 9 is a table showing first operation recognition information.

FIG. 10 is a table showing command conversion information.

FIG. 11 is a table showing first correspondence relationship information.

FIG. 12 is a table showing second correspondence relationship information.

FIG. 13 is a diagram schematically showing a state where a first correspondence relationship and a second correspondence relationship are set.

FIG. 14 is a diagram schematically showing a state where a movement direction of the list image is decided based on the first correspondence relationship and the list image is moved in the decided movement direction.

FIG. 15 is a diagram schematically showing a state where a movement direction of the list image is decided based on the second correspondence relationship and the list image is moved in the decided movement direction.

FIG. 16 is a flowchart showing a processing procedure of the digital camera.

FIG. 17 is a flowchart showing a processing procedure of the digital camera.

FIG. 18 is a flowchart showing a processing procedure of the digital camera.

FIG. 19 is a diagram showing a list image according to a second embodiment in which a cursor is set as an operation target.

FIG. 20 is a table showing first correspondence relationship information according to the second embodiment.

FIG. 21 is a table showing second correspondence relationship information according to the second embodiment.

FIG. 22 is a table showing command conversion information according to the second embodiment.

FIG. 23 is a diagram schematically showing a state where a movement direction of the cursor is decided based on a first correspondence relationship and the list image is moved in the decided movement direction.

FIG. 24 is a table showing first correspondence relationship information according to a third embodiment.

FIG. 25 is a table showing second correspondence relationship information according to the third embodiment.

FIG. 26 is a table showing command conversion information according to the third embodiment.

FIG. 27 is a diagram showing a case where a cursor is an operation target.

FIG. 28 is a diagram showing a case where a list image is an operation target.

FIG. 29 is a diagram schematically showing a state where a movement direction of the list image is decided based on a first correspondence relationship and the list image is moved in the decided movement direction.

FIG. 30 is a flowchart showing a processing procedure of a digital camera according to the third embodiment.

FIG. 31 is a diagram showing a state where a swipe operation or a flick operation is performed on a portion corresponding to an item.

FIG. 32 is a diagram showing a state where a swipe operation or a flick operation is performed on a portion corresponding to a background image.

FIG. 33 is a table showing command conversion information according to a fourth embodiment.

FIG. 34 is a diagram schematically showing a state where an item is moved in response to a swipe operation or a flick operation on a portion corresponding to an item.

FIG. 35 is a block diagram showing a command output unit according to a fifth embodiment.

FIG. 36 is a flowchart showing a processing procedure of a digital camera according to the fifth embodiment.

FIG. 37 is a diagram showing a mechanical-type operation unit group having a rotary wheel.

FIG. 38 is a table showing second correspondence relationship information in a case where the mechanical-type operation unit group shown in FIG. 37 is used.

### DESCRIPTION OF THE PREFERRED EMBODIMENTS

### First Embodiment

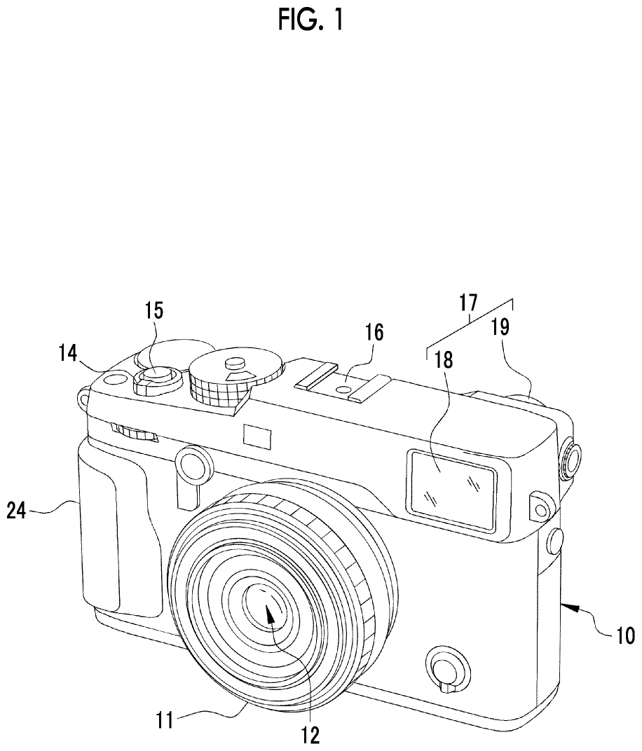

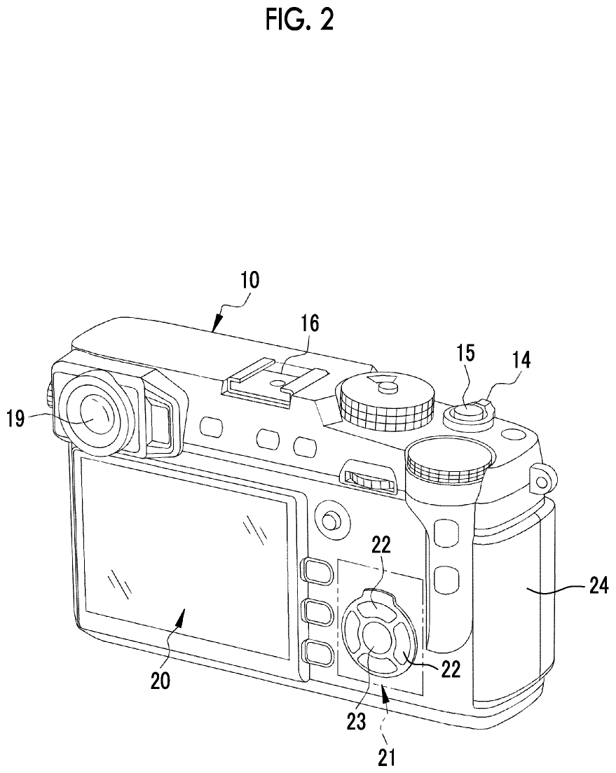

In FIGS. 1 and 2, a lens barrel 11 is provided on a front surface of a digital camera 10 as an imaging device. An imaging optical system 12 is built in the lens barrel 11. The lens barrel 11 is interchangeable, and the digital camera 10 is a so-called lens interchangeable type.

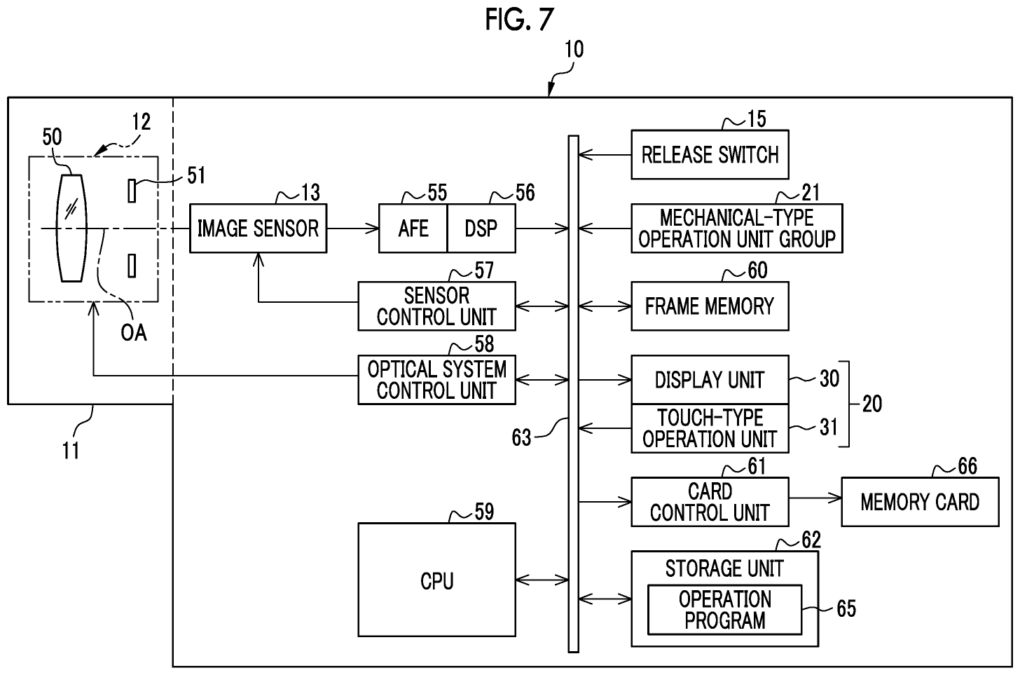

An image sensor 13 is disposed behind the lens barrel 11 (refer to FIG. 7). The image sensor 13 is, for example, a charge coupled device (CCD) type or a complementary metal oxide semiconductor (CMOS) type, and has a rectangular imaging surface. A plurality of pixels are arranged in a matrix on the imaging surface. The pixel photoelectrically converts a subject image formed on the imaging surface through the imaging optical system 12 and outputs an imaging signal which is a source of image data of a subject.

A power lever 14, a release switch 15, a hot shoe 16 and the like are provided on an upper surface of the digital camera 10. The power lever 14 is operated in a case where the digital camera 10 is turned on and off. An external flash device is attachably and detachably attached to the hot shoe 16.

The release switch 15 is operated in a case where still picture imaging is instructed or in a case where a start and an end of motion picture imaging is instructed. The release switch 15 is a two-stage press type. In a case where the release switch 15 is pressed down to a first stage (half-pressed), well-known imaging preparation processing such as automatic focus adjustment or automatic exposure control is executed. In a case where the release switch 15 is pressed down to a second stage (fully pressed), the image sensor 13 is caused to execute a main imaging operation (operation of accumulating charges in pixels and outputting an imaging signal corresponding to the accumulated charges). As a result, imaging processing of recording image data output from the image sensor 13 as a captured image is executed.

A viewfinder part 17 has an object window 18 which is disposed on the front surface and through which the subject image is captured, and an eyepiece window 19 which is disposed on a rear surface and through which an eye of a user views. It is possible for the user to check the composition of the subject image to be imaged through the viewfinder part 17.

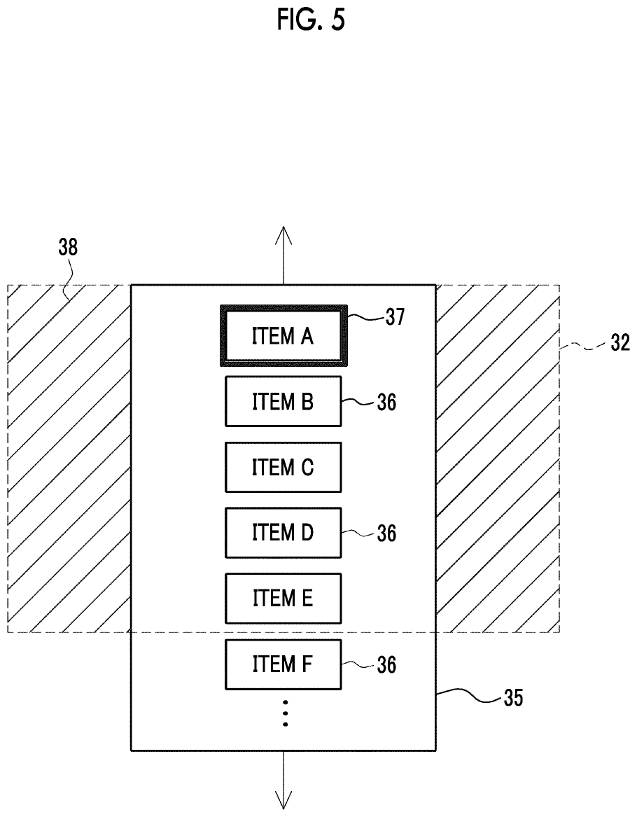

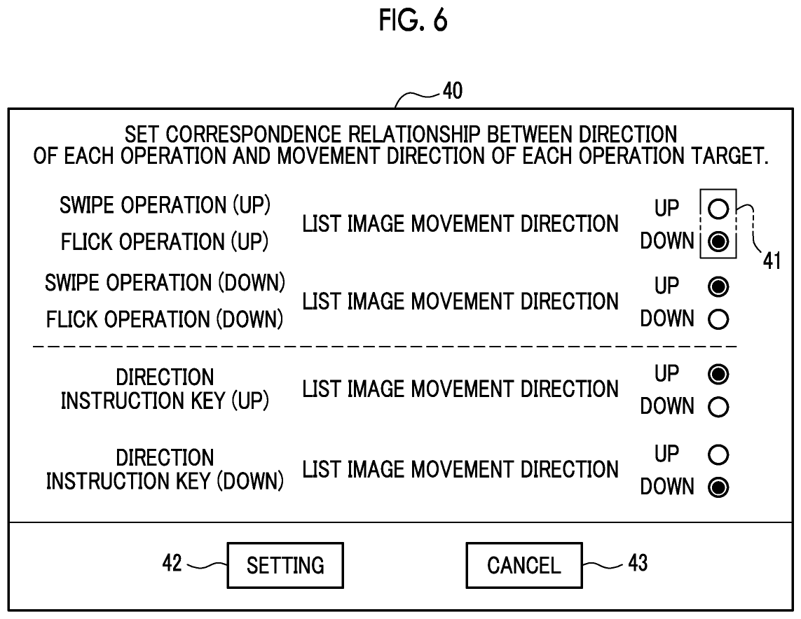

A touch panel display 20, a mechanical-type operation unit group 21, and the like are provided on the rear surface of the digital camera 10. The touch panel display 20 performs a so-called live view display that displays the captured image of the subject represented by the image data from the image sensor 13 in real time. In addition to the live view display, the touch panel display 20 performs reproduction display of a recorded captured image or displays various images such as a list image 35 (refer to FIG. 5) in which various items 36 as selection candidates are arranged or a setting image 40 (refer to FIG. 6) for setting a first correspondence relationship and a second correspondence relationship.

The mechanical-type operation unit group 21 is composed of a direction instruction key 22 and a menu/decision button 23. The above has a mechanical structure and has a shape and operation feeling that can be tactilely perceived such as an uneven shape. The direction instruction key 22 is composed of four keys for performing an instruction for respective directions of up, down, left, and right, and is operated in a case where various items 36 are selected. The menu/decision button 23 is disposed in the center of the mechanical-type operation unit group 21 and is operated in a case where the list image 35 is displayed, in a case where the selection of various items is confirmed, and the like. A portion indicated by a reference sign 24 in FIGS. 1 and 2 is a lid for covering a memory card slot in which a memory card 66 (refer to FIG. 7) is attachably and detachably mounted.

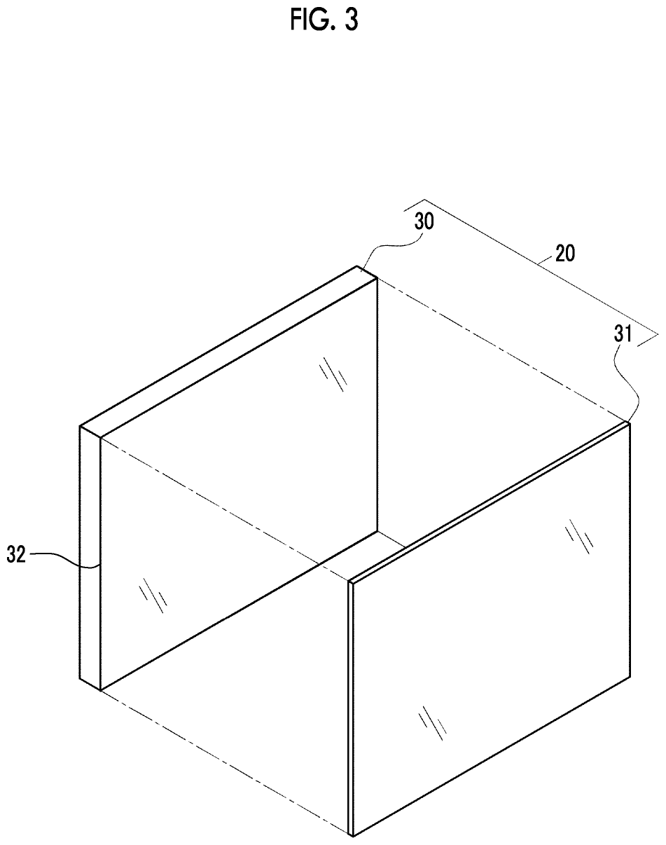

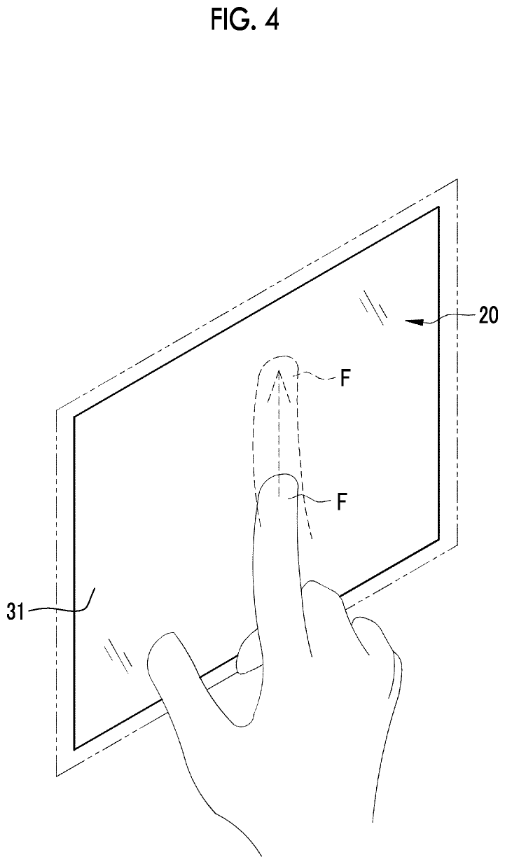

FIG. 3 schematically represents a configuration of the touch panel display 20. The touch panel display 20 is composed of a display unit 30 and a touch-type operation unit 31. The display unit 30 is, for example, a liquid crystal display, and a screen 32 thereof displays the various images as described above. As is well known, the touch-type operation unit 31 has two layers of transparent electrodes that are orthogonal to each other, a transparent insulating layer that separates the two layers of transparent electrodes, and a transparent protection cover that covers the uppermost layer. The touch-type operation unit 31 detects a touch of a finger F of the user (refer to FIG. 4) with the transparent electrode and outputs a detection signal. The touch-type operation unit 31 is disposed on the screen 32 of the display unit 30 in an overlapped manner. The touch panel display 20 is attached to the rear surface of the digital camera 10 as shown in FIG. 2 in a state where the display unit 30 and the touch-type operation unit 31 are integrated.

The touch panel display 20 recognizes a first operation which is a gesture operation by the finger F of the user touching the touch-type operation unit 31. The first operation includes, for example, a swipe operation and a flick operation. The swipe operation is an operation in which the finger F is brought to touch the touch-type operation unit 31, is slowly moved in a certain direction, and then is released from the touch-type operation unit 31. The flick operation is an operation in which the finger F is brought to touch the touch-type operation unit 31 and is quickly swept in a certain direction to be released from the touch-type operation unit 31. The swipe operation or the flick operation is performed, for example, in a case where the various items 36 are selected, similar to the direction instruction key 22 of the mechanical-type operation unit group 21.

FIG. 4 shows a state of an upward swipe operation or flick operation on the touch-type operation unit 31. The user brings the finger F (here, index finger) into touch with an appropriate position of the touch-type operation unit 31, slowly moves the finger F upward (swipe operation) or quickly sweeps the finger F upward (flick operation) as indicated by a dashed arrow, and then releases the finger F from the touch-type operation unit 31.

The first operation includes a tap operation, a pinch-in operation, a pinch-out operation, and the like, in addition to the swipe operation and the flick operation illustrated in FIG. 4. The tap operation is an operation of tapping the touch-type operation unit 31 with the finger F and includes a single tap operation of tapping once and a double tap operation of tapping twice consecutively. The pinch-in operation is an operation in which at least two fingers F such as the thumb and the index finger are brought into touch with the touch-type operation unit 31 in a state where the two fingers are separated and then the two fingers F are moved in directions approaching each other. On the contrary, the pinch-out operation is an operation in which two fingers F are brought into touch with the touch-type operation unit 31 in a state where the two fingers approach and then the two fingers F are moved in directions away from each other.

The tap operation is performed in a case where the selection of the item 36 is confirmed, similar to the menu/decision button 23 of the mechanical-type operation unit group 21. The pinch-in operation is performed in a case where a captured image subjected to the reproduction display is reduced, and the pinch-out operation is performed in a case where a captured image subjected to the reproduction display is enlarged.

In FIG. 5, the list image 35 is an image in which the items 36 (items A, B, C, D, E, F, and the like) as selection candidates are arranged in a longitudinal direction. A size in the longitudinal direction of the list image 35 does not fit on the screen 32 at one time. For this reason, the list image 35 moves up and down with respect to the screen 32 in response to the first and second operations, as indicated by arrows. That is, the list image 35 is an operation target in the present embodiment.

The first operation is, specifically, an upward swipe and flick operations, and a downward swipe operation and flick operation. The second operation is an operation performed through the direction instruction key 22 which is a mechanical-type operation unit, and specifically, an upward operation of the direction instruction key 22 and a downward operation of the direction instruction key 22.

A cursor 37 for selecting one of the plurality of items 36 is displayed in the list image 35. The display of the cursor 37 is fixed at an upper end of the screen 32. For this reason, the cursor 37 is not the operation target in the present embodiment. The item 36 is, for example, an option of a visual effect (monochrome, sepia, vivid, or the like) to be performed to the captured image.

The list image 35 is superimposed on a background image 38 indicated by hatching. The background image 38 is, for example, a plain image set in advance or a captured image selected by the user and is displayed in a fixed manner on the screen 32. In FIG. 5, a width of the list image 35 is made larger than a width of the item 36 and a margin is provided in the list image 35. However, the width of the list image 35 may be made the same as the width of the item 36 and the margin may be not provided in the list image 35.

In FIG. 6, the setting image 40 is an operation image to be displayed on the screen 32 of the display unit 30 in a case where the first correspondence relationship and the second correspondence relationship are set. The first correspondence relationship is a correspondence relationship between a direction of the first operation and a movement direction of the list image 35 to be operated with respect to the screen 32 in response to the first operation. The second correspondence relationship is a correspondence relationship between a direction of the second operation and a movement direction of the list image 35 with respect to the screen 32 in response to the second operation.

The setting image 40 is provided with a radio button 41 for alternatively setting the movement direction of the list image 35 with respect to each operation direction to any one of up or down, a setting button 42, and a cancel button 43. In a case where the setting button 42 is selected, a selected state of the radio button 41 at the time is set as the first correspondence relationship and the second correspondence relationship. On the other hand, in a case where the cancel button 43 is selected, the setting image 40 is deleted from the screen 32.

In FIG. 6, the movement direction of the list image 35 is set to down for the upward swipe and flick operations. On the other hand, the movement direction of the list image 35 is set to up for the downward swipe and flick operations. The movement direction of the list image 35 is set to up for the upward operation of the direction instruction key 22 and the movement direction of the list image 35 is set to down for the downward operation of the direction instruction key 22, respectively.

In FIG. 7, the imaging optical system 12 comprises a movable lens 50 and a stop mechanism 51. The movable lens 50 is a focus lens for focus adjustment and a zoom lens for zoom, and moves along an optical axis OA. The stop mechanism 51 has a plurality of stop leaf blades, as is well known. The stop leaf blades form a substantially circular aperture stop, and a size of the aperture stop is changed to limit an amount of incident light. Although not shown or described, the imaging optical system 12 has various lenses in addition to the movable lens 50.

The digital camera 10 comprises an analog front end (AFE) 55, a digital signal processor (DSP) 56, a sensor control unit 57, an optical system control unit 58, a central processing unit (CPU) 59, a frame memory 60, a card control unit 61, and a storage unit 62. These are connected to each other by a data bus 63.

The AFE 55 performs correlative double sampling processing or amplification processing, and analog/digital conversion processing on an analog imaging signal from the image sensor 13 to convert the analog imaging signal into image data having a gradation value corresponding to a predetermined number of bits, and outputs the image data to the DSP 56. The DSP 56 performs well-known signal processing such as gamma-correction processing, defective pixel correction processing, white balance correction processing, and demosaicing on the image data from the AFE 55.

The sensor control unit 57 controls the operation of the image sensor 13. Specifically, the sensor control unit 57 outputs a sensor control signal synchronized with a reference clock signal to be input from the CPU 59 to the image sensor 13 and causes the image sensor 13 to output the imaging signal at a predetermined frame rate.

The optical system control unit 58 moves the movable lens 50 to a focusing position during automatic focus adjustment. The optical system control unit 58 opens and closes the stop leaf blades of the stop mechanism 51 such that a calculated opening is obtained, during the automatic exposure control.

The CPU 59 integrally controls the operation of each unit of the digital camera 10 based on an operation program 65 stored in the storage unit 62. For example, the CPU 59 executes the imaging preparation processing in response to the half press of the release switch 15 and executes the imaging processing in response to the full press of the release switch 15. The CPU 59 executes processing according to an operation signal from the mechanical-type operation unit group 21. FIG. 7 illustrates only the release switch 15 and the mechanical-type operation unit group 21. However, other mechanical-type operation units such as the power lever 14 described above are also connected to the data bus 63, and processing according to operation signals from the other units is executed by the CPU 59.

The frame memory 60 stores one-frame image data subjected to various types of signal processing by the DSP 56. The image data to be stored in the frame memory 60 is updated at any time at a predetermined frame rate.

The card control unit 61 controls recording of the captured image on the memory card 66 and reading out of the captured image from the memory card 66. In the imaging processing accompanying the full press of the release switch 15, the card control unit 61 records the image data stored in the frame memory 60 at the time on the memory card 66 as the captured image.

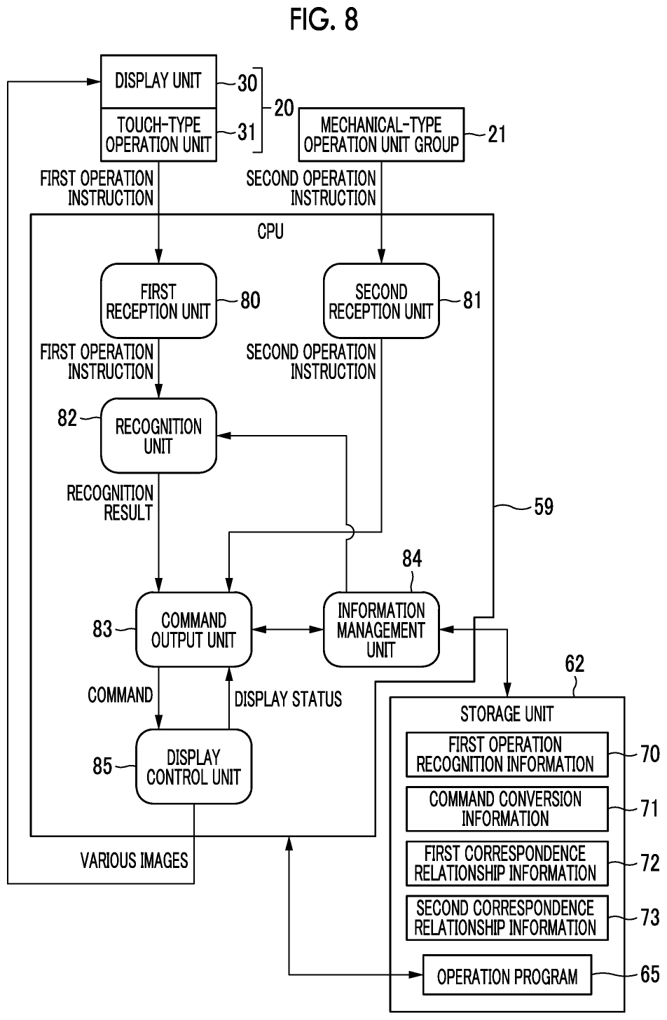

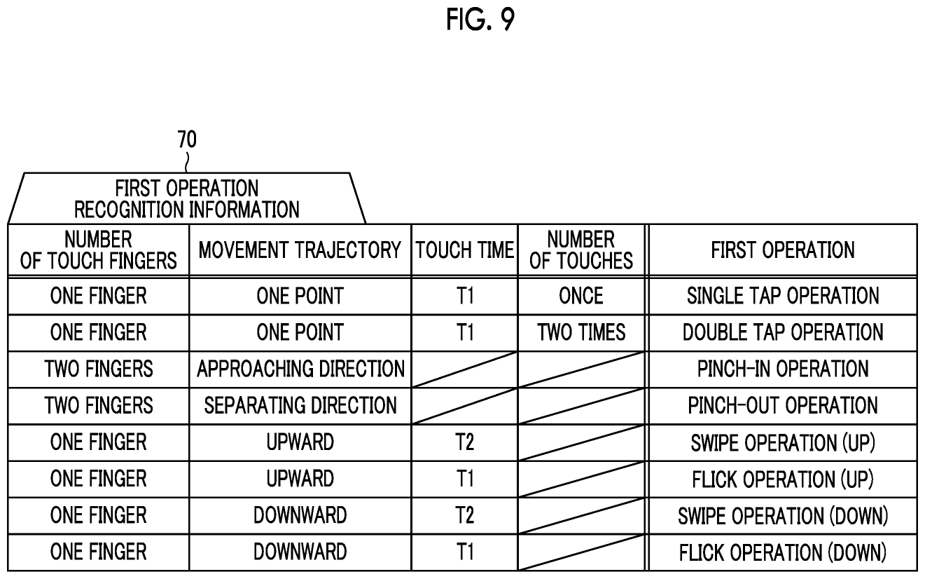

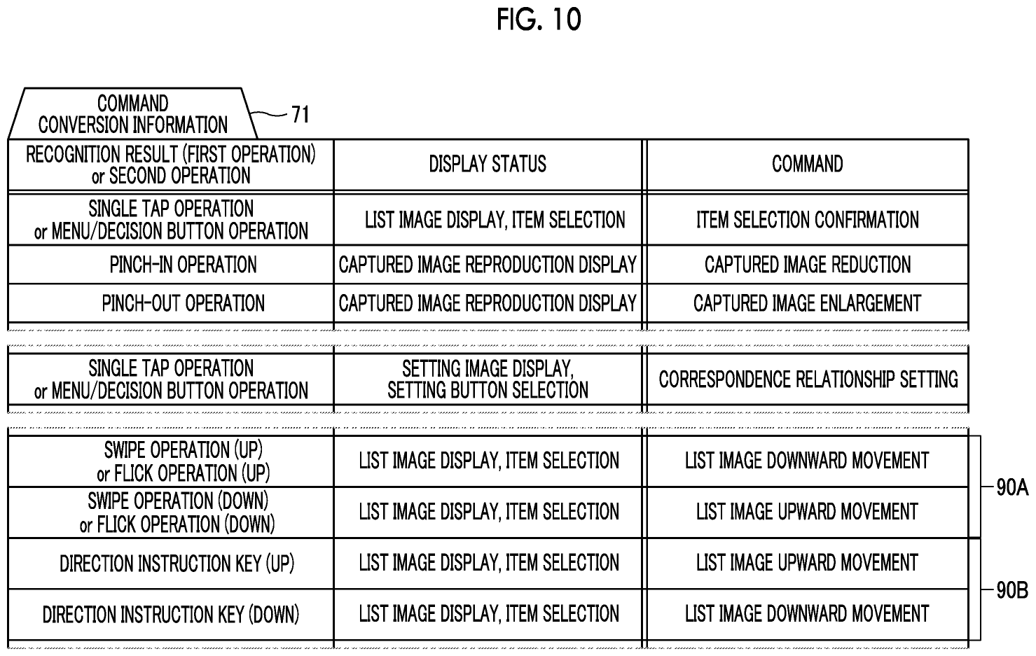

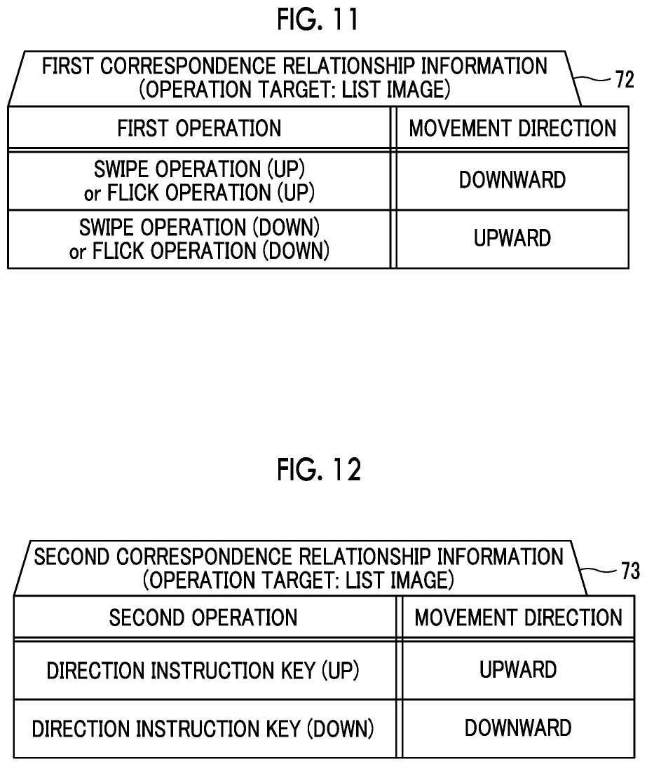

In FIG. 8, the storage unit 62 stores first operation recognition information 70 (refer to FIG. 9), command conversion information 71 (refer to FIG. 10), first correspondence relationship information 72 (refer to FIG. 11), and second correspondence relationship information 73 (refer to FIG. 12) in addition to the above operation program 65.

In a case where the operation program 65 is activated, the CPU 59 functions as a first reception unit 80, a second reception unit 81, a recognition unit 82, a command output unit 83, an information management unit 84, and a display control unit 85.

The first reception unit 80 receives an operation instruction by the first operation (hereinafter first operation instruction) performed on the touch-type operation unit 31. The first reception unit 80 outputs the first operation instruction to the recognition unit 82. On the other hand, the second reception unit 81 receives an operation instruction by the second operation (hereinafter second operation instruction) performed on the mechanical-type operation unit group 21. The second reception unit 81 outputs the second operation instruction to the command output unit 83.

The first operation instruction includes a touch position of the finger F on the touch-type operation unit 31, coordinate information indicating a movement trajectory thereof, and information such as the number of touch fingers F, a touch time, and the number of touches per unit time on the touch-type operation unit 31. The coordinate is, for example, two sets of numbers indicating an intersection of the two layers of transparent electrodes that constitute the touch-type operation unit 31 and are orthogonal to each other. On the other hand, the second operation instruction is an operation signal of any one of the up, down, left, and right keys of the direction instruction key 22, information indicating an operation time thereof, and an operation signal of the menu/decision button 23.

The first operation instruction and the second operation instruction include a setting instruction for the first correspondence relationship and the second correspondence relationship. The setting instruction is output from the touch-type operation unit 31 to the first reception unit 80 or from the mechanical-type operation unit group 21 to the second reception unit 81 in a case where the setting button 42 of the setting image 40 is selected. That is, the first reception unit 80 and the second reception unit 81 correspond to a reception unit that receives the setting instruction and have a reception function of the setting instruction.

The recognition unit 82 refers to the first operation recognition information 70 to recognize which of the above swipe operation, flick operation, tap operation, pinch-in operation, pinch-out operation, or the like is the first operation that is a source of the first operation instruction from the first reception unit 80. In a case of the swipe operation, the flick operation, the pinch-in operation, and the pinch-out operation, a movement amount and a movement speed of the finger F are recognized from the movement trajectory of the finger F. The recognition unit 82 outputs the recognition result to the command output unit 83.

The command output unit 83 refers to the command conversion information 71 and a display status from the display control unit 85 to convert the recognition result from the recognition unit 82 and the second operation instruction from the second reception unit 81 into a command. The converted command is output to various processing units such as the information management unit 84 and the display control unit 85. The command is obtained by converting the recognition result (in other words, the first operation instruction) and the second operation instruction into a form that can be understood by the information management unit 84, the display control unit 85, and the like. The display status is information indicating a display situation of the various images on the screen 32 of the display unit 30, such as a reproduction display state of the captured image, a display state of the list image 35, and the like.

The information management unit 84 manages writing of various pieces of information 70 to 73 into the storage unit 62 and reading out of various pieces of information 70 to 73 from the storage unit 62. For example, the information management unit 84 passes the first operation recognition information 70 to the recognition unit 82 and passes the command conversion information 71 to the command output unit 83.

The display control unit 85 has a display control function of controlling the display of the various images on the screen 32 of the display unit 30. The display control unit 85 outputs the display state of the various images to the command output unit 83 as the display status. Therefore, the command output unit 83 always grasps the display status.

The CPU 59 is provided with an image processing unit for performing a visual effect selected as the item 36 in the list image 35 on the captured image, in addition to the above units.

In FIG. 9, the first operation recognition information 70 is information in which the first operation for the number of touch fingers F, the movement trajectory, the touch time, and the number of touches per unit time on the touch-type operation unit 31 is registered. For example, in a case where the number of touch fingers is one, the movement trajectory is one point, the touch time is T1 (for example, less than one second), and the number of touches is once, the single tap operation is registered. In a case where the number of touch fingers is one, the movement trajectory is upward, and the touch time is T2 (for example, one second or more), the upward swipe operation is registered. In a case where the number of touch fingers and the movement trajectory are the same and the touch time is T1, the upward flick operation is registered.

The recognition unit 82 extracts, from the first operation recognition information 70, a first operation that matches the number of touch fingers F, the movement trajectory, the touch time, and the number of touches per unit time on the touch-type operation unit 31 which are included in the first operation instruction from the first reception unit 80. The extracted first operation is output to the command output unit 83 as the recognition result. For example, in a case where the number of touch fingers F on the touch-type operation unit 31 is two and the movement trajectory thereon is in an approaching direction, which are included in the first operation instruction, the recognition unit 82 extracts the pinch-in operation from the first operation recognition information 70 and outputs the extracted pinch-in operation to the command output unit 83.

In FIG. 10, the command conversion information 71 is information in which the command for the recognition result (first operation) or the second operation, and the display status is registered. For example, in a case where the single tap operation is performed as the first operation or the menu/decision button 23 is operated as the second operation in a display status where a desired item 36 is selected by the cursor 37 in the list image 35, a command to confirm the selection of the item 36 is registered. On the other hand, in a case where the single tap operation is performed as the first operation or the menu/decision button 23 is operated as the second operation in a display status where the setting button 42 is selected in the setting image 40, a command to set the first correspondence relationship and the second correspondence relationship is registered. As described above, in a case where the display status is different, the command is different even with the same first and second operations.

Further, in a case where the upward swipe operation or flick operation is performed as the first operation in a display status where the item 36 is selected in the list image 35, a command to move the list image 35 downward is registered. On the other hand, in a case where the upward operation of the direction instruction key 22 is performed as the second operation, a command to move the list image 35 upward is registered.

In a case where the downward swipe operation or flick operation is performed as the first operation in the display status where the item 36 is selected in the list image 35, a command to move the list image 35 upward is registered. On the other hand, in a case where the downward operation of the direction instruction key 22 is performed as the second operation, a command to move the list image 35 downward is registered.

In FIG. 11, the first correspondence relationship information 72 is information in which the direction of the first operation and the movement direction of the list image 35 to be operated with respect to the screen 32, that is, the first correspondence relationship is registered. Similarly, in FIG. 12, the second correspondence relationship information 73 is information in which the direction of the second operation and the movement direction of the list image 35 with respect to the screen 32, that is, the second correspondence relationship is registered. In FIGS. 11 and 12, the first correspondence relationship and the second correspondence relationship shown in FIG. 6 are registered. Note that the first correspondence relationship information 72 and the second correspondence relationship information 73 may be integrated into one piece of correspondence relationship information.

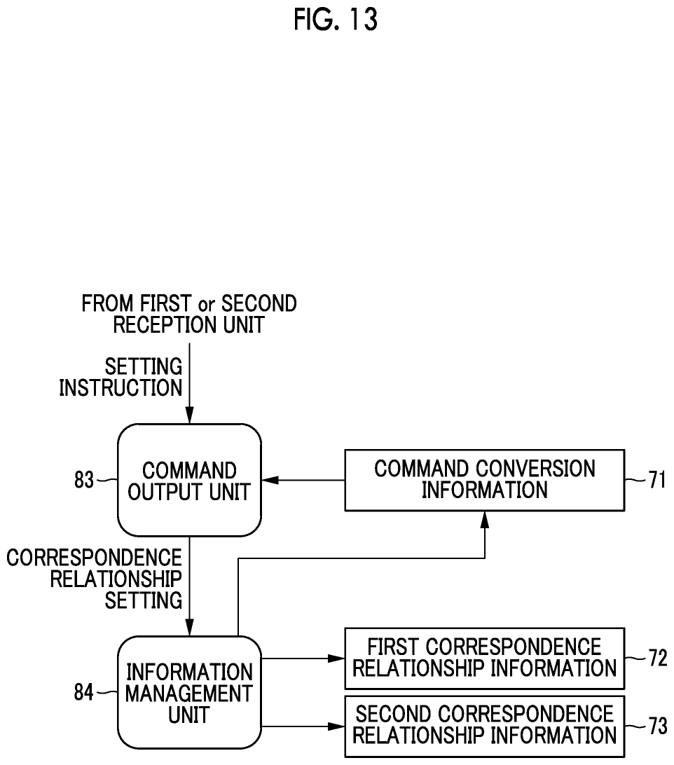

As shown in FIG. 13, the command output unit 83 outputs the command to set the first correspondence relationship and the second correspondence relationship to the information management unit 84 in response to the setting instruction from the first reception unit 80 or the second reception unit 81. The information management unit 84 registers the first correspondence relationship in the first correspondence relationship information 72 and the second correspondence relationship in the second correspondence relationship information 73 in response to the command, respectively. The information management unit 84 registers a command of a portion 90A (refer to FIG. 10) of the swipe operation or flick operation in the command conversion information 71 based on the first correspondence relationship information 72, and registers a command of a portion 90B (refer to FIG. 10) of the operation of the direction instruction key 22 based on the second correspondence relationship information 73. Accordingly, the first correspondence relationship and the second correspondence relationship are set. That is, the information management unit 84 corresponds to a setting unit that sets the first correspondence relationship and the second correspondence relationship in response to the setting instruction received by the first reception unit 80 or the second reception unit 81, and has a setting function.

The setting instruction is actually recognized by the recognition unit 82 and the recognition result is output to the command output unit 83. However, the setting instruction is assumed to be output from the first reception unit 80 to the command output unit 83 in FIG. 13 for simplifying a description.

In a case where the first operation or the second operation is performed, the command output unit 83 decides the movement direction of the list image 35 with respect to the screen 32 based on the first correspondence relationship or the second correspondence relationship. That is, the command output unit 83 corresponds to a deciding unit and has a deciding function. The command output unit 83 outputs the command to move the list image 35 in the decided movement direction to the display control unit 85. The display control unit 85 moves the list image 35 in the movement direction indicated by the command.

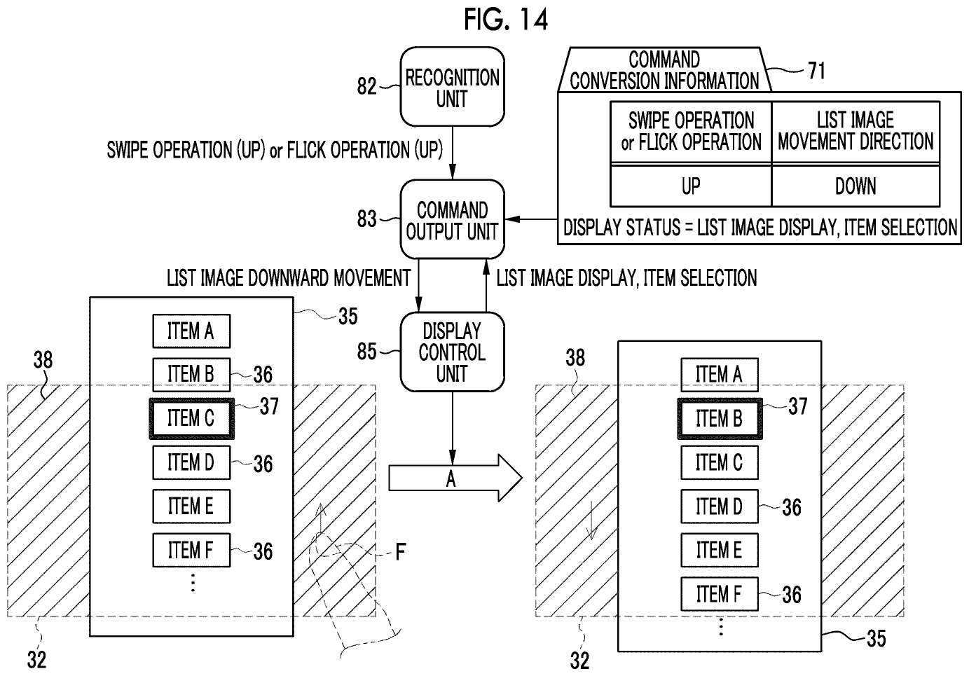

FIG. 14 shows a case where the upward swipe operation or flick operation is performed as the first operation in the display status where the item 36 is selected in the list image 35. In this case, the command output unit 83 refers to the command conversion information 71 generated by the portion 90A based on the first correspondence relationship information 72 to output the command to move the list image 35 downward to the display control unit 85. The display control unit 85 moves the list image 35 downward in response to the command.

The list image 35 is in a state where, for example, the item C is selected by the cursor 37 as shown on the left side of an arrow A, before the upward swipe operation or flick operation is performed. In a case where the upward swipe operation or flick operation is performed from this state, the list image 35 is moved downward as shown on the right side of the arrow A and is in a state where, for example, the item B is selected by the cursor 37. In a case where the downward swipe operation or flick operation is performed, only the movement direction of the list image 35 is reversed. Therefore, an illustration and a description of the case are omitted.

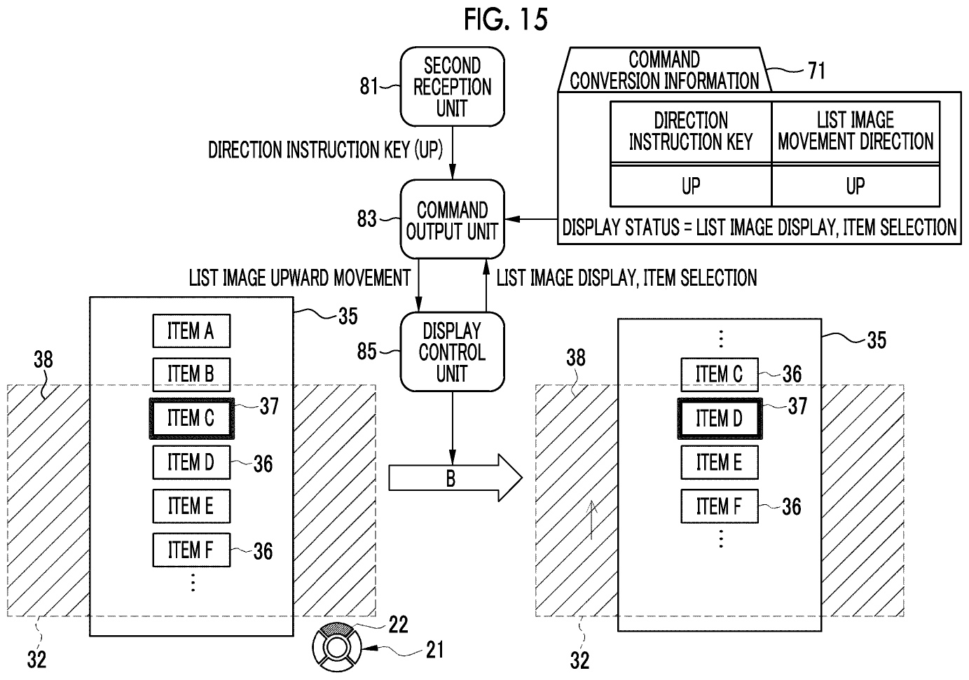

On the other hand, FIG. 15 shows a case where the upward operation of the direction instruction key 22 is performed as the second operation in the display status where the item 36 is selected in the list image 35. In this case, the command output unit 83 outputs the command to move the list image 35 upward to the display control unit 85, contrary to the case of FIG. 14. The display control unit 85 moves the list image 35 upward in response to the command.

The left side of an arrow B is a state where the item C is selected by the cursor 37 as in the left side of the arrow A in FIG. 14. In a case where the upward operation of the direction instruction key 22 is performed from this state, the list image 35 is moved upward as shown on the right side of the arrow B and is in a state where, for example, the item D is selected by the cursor 37. In a case where the downward operation of the direction instruction key 22 is performed, only the movement direction of the list image 35 is reversed. Therefore, an illustration and a description of the case are omitted.

A movement amount of the list image 35 with respect to the screen 32 depends on the movement amount and the movement speed of the finger F. The movement amount of the list image 35 with respect to the screen 32 is larger as the movement amount of the finger F is large and the movement speed is high.

As described above, the first reception unit 80 and the second reception unit 81 correspond to the reception unit, and the information management unit 84 corresponds to the setting unit. The command output unit 83 corresponds to the deciding unit. Therefore, the operation device according to the present invention is composed of the touch panel display 20, the direction instruction key 22 as the mechanical-type operation unit, the first reception unit 80 and the second reception unit 81 as the reception unit, the information management unit 84 as the setting unit, the command output unit 83 as the deciding unit, and the display control unit 85. The operation device according to the present invention is used for the digital camera 10 as the imaging device.

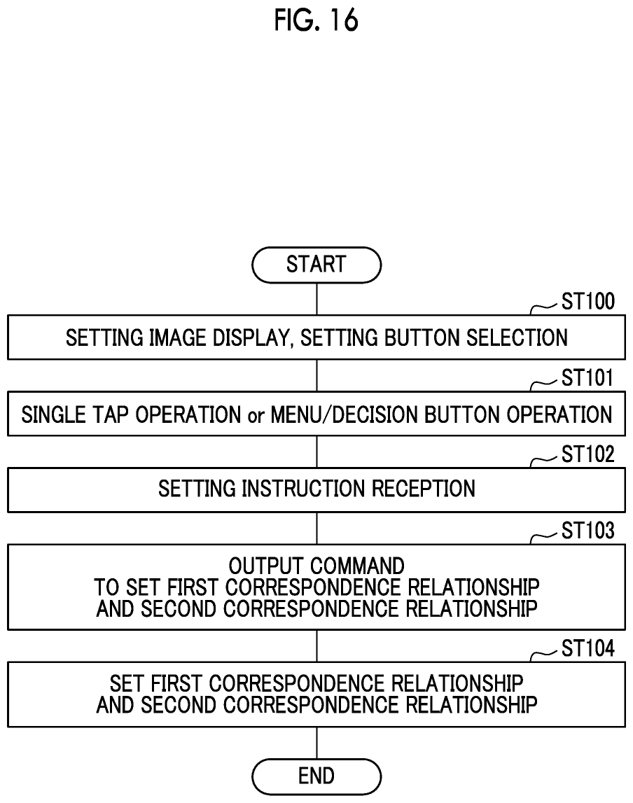

Next, an action by the above configuration will be described with reference to flowcharts of FIGS. 16 to 18. First, as shown in FIG. 16, in a case where the single tap operation or the menu/decision button 23 is operated (step ST101) in a display status where the setting button 42 is selected in the setting image 40 (step ST100), the first reception unit 80 or the second reception unit 81 receives the setting instruction (step ST102, reception step).

As shown in FIG. 13, the setting instruction is output from the first reception unit 80 or the second reception unit 81 to the command output unit 83. In response to this setting instruction, the command to set the first correspondence relationship and the second correspondence relationship is output from the command output unit 83 to the information management unit 84 (step ST103). The information management unit 84, which receives the command to set the first correspondence relationship and the second correspondence relationship, registers the first correspondence relationship to the first correspondence relationship information 72 and the second correspondence relationship to the second correspondence relationship information 73, respectively. Further, the command of the portion 90A of the swipe operation or flick operation in the command conversion information 71 is registered based on the first correspondence relationship information 72, and the command of the portion 90B of the operation of the direction instruction key 22 is registered based on the second correspondence relationship information 73. Accordingly, the first correspondence relationship and the second correspondence relationship are set (step ST104, setting step).

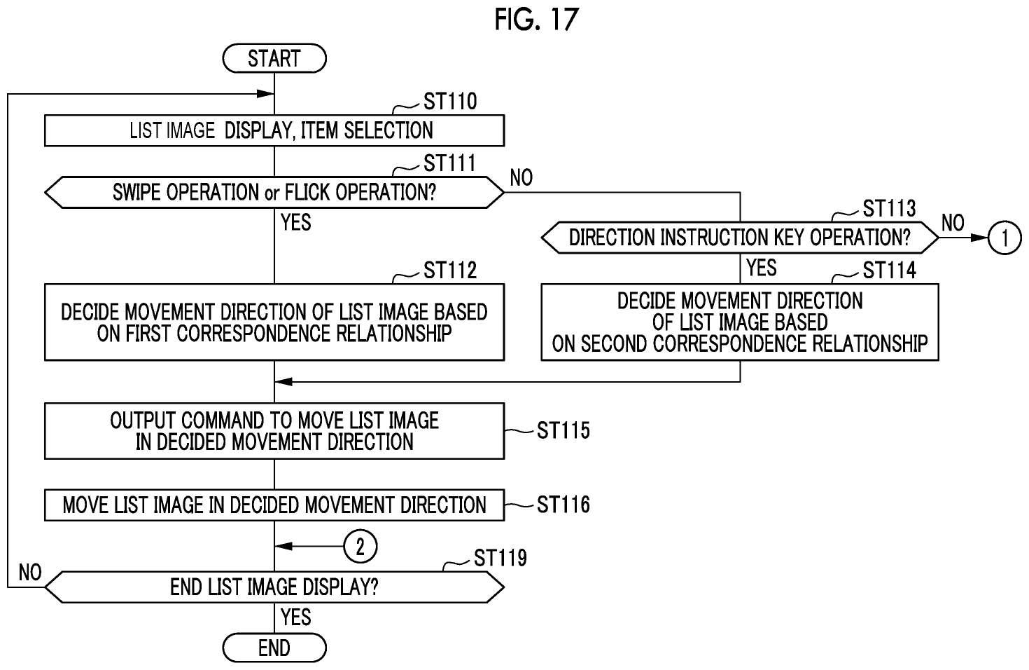

As shown in FIG. 17, in a case where the swipe operation or the flick operation is performed on touch-type operation unit 31 (YES in step ST111) in the display status where the item 36 is selected in the list image 35 (step ST110), the command output unit 83 decides the movement direction of the list image 35 with respect to the screen 32 based on the first correspondence relationship (step ST112, deciding step) as shown in FIG. 14.

On the other hand, in a case where the direction instruction key 22 is operated instead of the swipe operation or the flick operation (NO in step ST111, YES in step ST113), the command output unit 83 decides the movement direction of the list image 35 with respect to the screen 32 based on the second correspondence relationship as shown in FIG. 15 (step ST114, deciding step).

After the movement direction of list image 35 is decided, the command to move the list image 35 in the decided movement direction is output from the command output unit 83 to the display control unit 85 (step ST115). As shown on the right side of the arrow A in FIG. 14 and on the right side of the arrow B in FIG. 15, the display control unit 85 moves the list image 35 in the decided movement direction (step ST116, display control step).

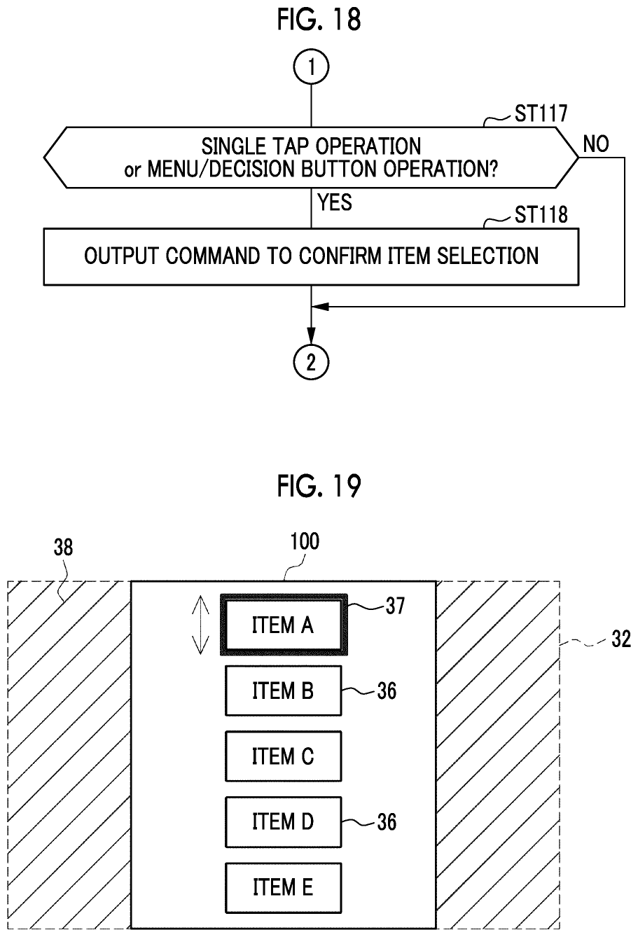

As shown in FIG. 18, in a case where the single tap operation or the menu/decision button 23 is operated (YES in step ST117) in the display status where the item 36 is selected in the list image 35 (step ST110), the command output unit From 83 outputs the command to confirm the selection of item 36 (step ST118). Accordingly, the selection of the item 36 is confirmed, and processing corresponding to the item 36, whose selection is confirmed, is executed. For example, in a case where the item 36 is the option of the visual effect to be performed to the captured image, the command to confirm the selection is output to the image processing unit and the image processing unit executes the processing of performing the visual effect, whose selection is confirmed, on the captured image.

The processing shown in steps ST110 to ST118 is repeatedly executed until the display of the list image 35 ends (YES in step ST119).

In a case where the first correspondence relationship and the second correspondence relationship are set and the first operation or the second operation is performed, the movement direction of the list image 35 with respect to the screen 32 is decided based on the set first correspondence relationship or second correspondence relationship and the list image 35 is moved in the decided movement direction. Therefore, it is possible to set the first correspondence relationship and the second correspondence relationship according to the preference of the user, for example, the same first correspondence relationship and second correspondence relationship as the operation device to which the user is accustomed, and to move the list image 35 based on these correspondence relationships.

The first correspondence relationship and the second correspondence relationship cannot be set and are fixed in the related art, and a user who feels uncomfortable in an initial operation with the fixed setting is required to perform the operation while dragging the uncomfortable feeling until the user is accustomed to the operation. On the contrary, according to the present invention, it is possible for the user to freely set the preferred first correspondence relationship and second correspondence relationship and thus to perform the operation without feeling uncomfortable from the initial operation.

### Second Embodiment

In a second embodiment shown in FIGS. 19 to 23, the cursor 37 is set as the operation target instead of the list image 35 according to the first embodiment.

In FIG. 19, a size in the longitudinal direction of a list image 100 according to the present embodiment fits on the screen 32 at one time. Therefore, the display of the list image 100 in an up-down direction is fixed with respect to the screen 32 in the present embodiment. On the other hand, the cursor 37 moves in the up-down direction with respect to the screen 32 in response to the first and second operations, as indicated by arrows. That is, the cursor 37 is the operation target in the present embodiment.

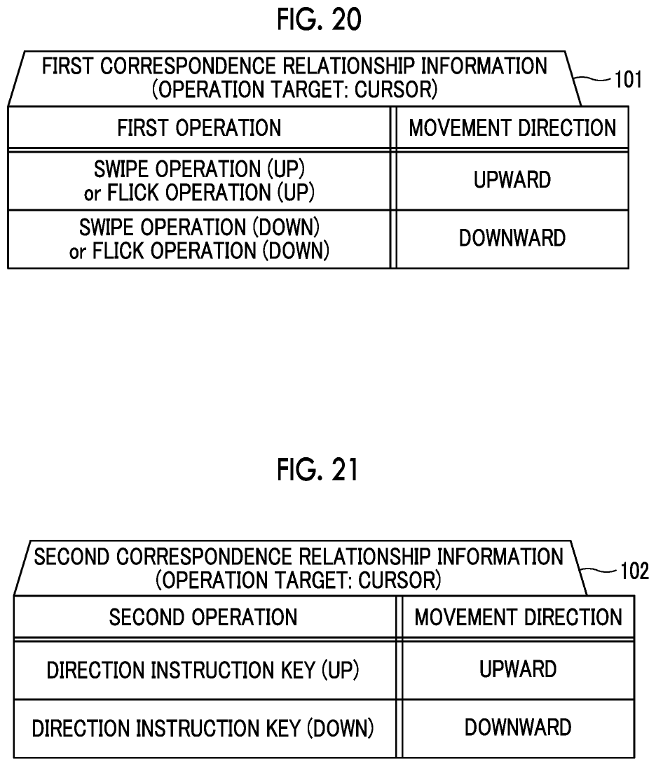

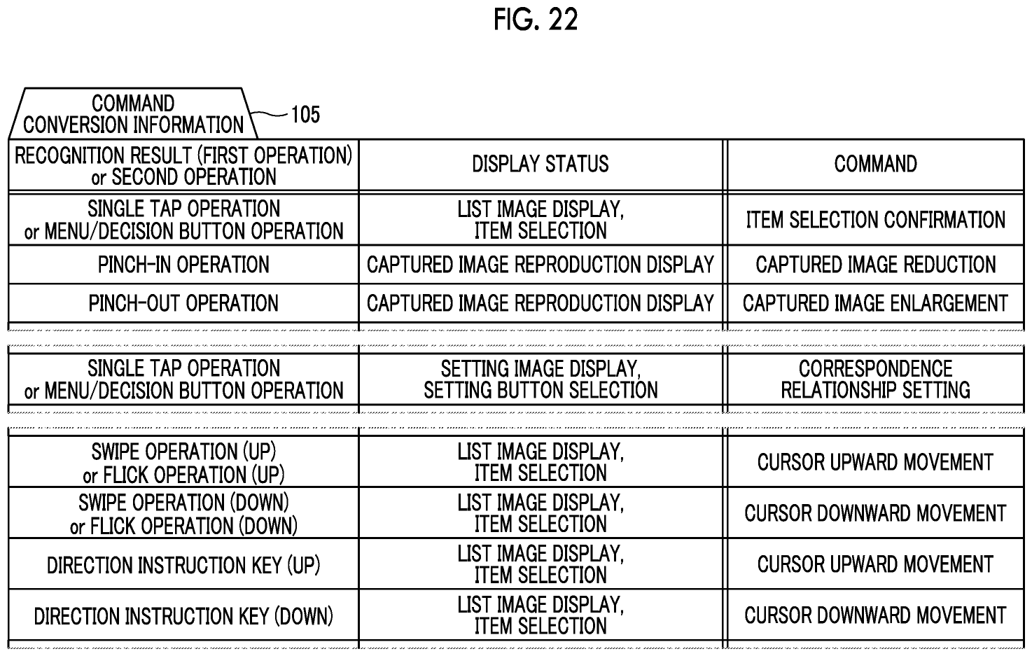

In this case, as shown in FIG. 20, a direction of the swipe operation or the flick operation and a movement direction of the cursor 37 to be operated are registered as the first correspondence relationship in first correspondence relationship information 101. As shown in FIG. 21, a direction of operation of the direction instruction key 22 and a movement direction of the cursor 37 are registered in second correspondence relationship information 102 as the second correspondence relationship. That is, the upward movement direction of the cursor 37 is set for the upward swipe and flick operations, and the downward movement direction of the cursor 37 is set for the downward swipe and flick operations. The upward movement direction of the cursor 37 is set for the upward operation of the direction instruction key 22, and the downward movement direction of the cursor 37 is set for the downward operation of the direction instruction key 22. Command conversion information 105 generated by the information management unit 84 based on the first correspondence relationship information 101 and the second correspondence relationship information 102 is as shown in FIG. 22.

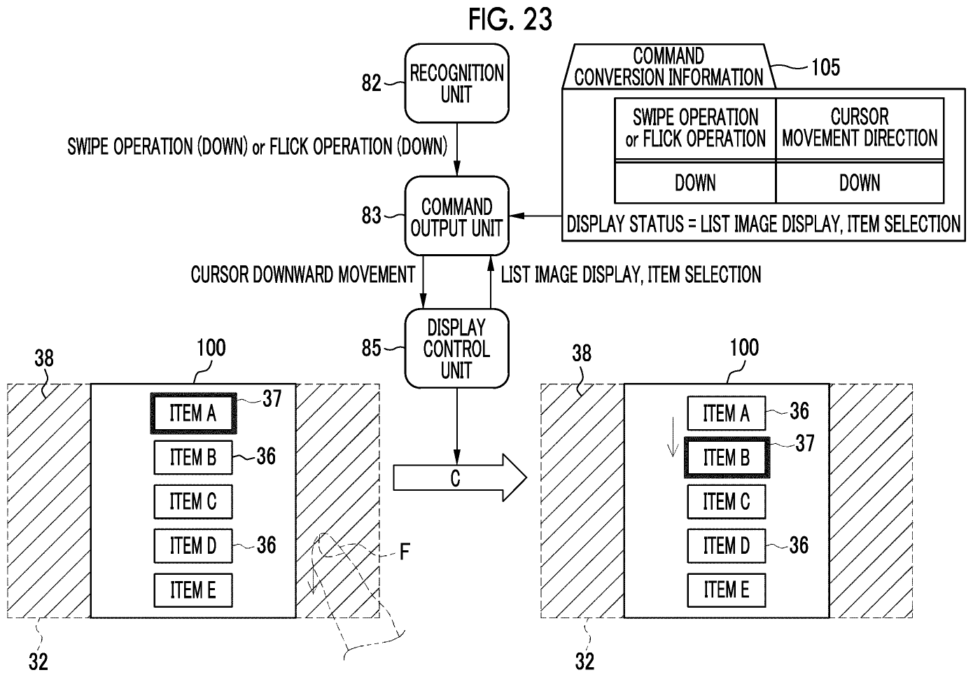

FIG. 23 shows a case where the downward swipe operation or flick operation is performed as the first operation in a display status where the item 36 is selected in the list image 100, as in the case of FIG. 14. In this case, the command output unit 83 refers to the command conversion information 105 to output a command to move the cursor 37 downward to the display control unit 85. The display control unit 85 moves the cursor 37 downward in response to the command.

The cursor 37 is in a state where, for example, the item A is selected as shown on the left side of an arrow C before the downward swipe operation or flick operation is performed. In a case where the downward swipe operation or flick operation is performed from this state, the cursor 37 is moved downward as shown on the right side of the arrow C and is in a state where, for example, the item B is selected. An illustration and a description of an example of a case where the direction instruction key 22 corresponding to FIG. 15 of the first embodiment is operated are omitted.

### Third Embodiment

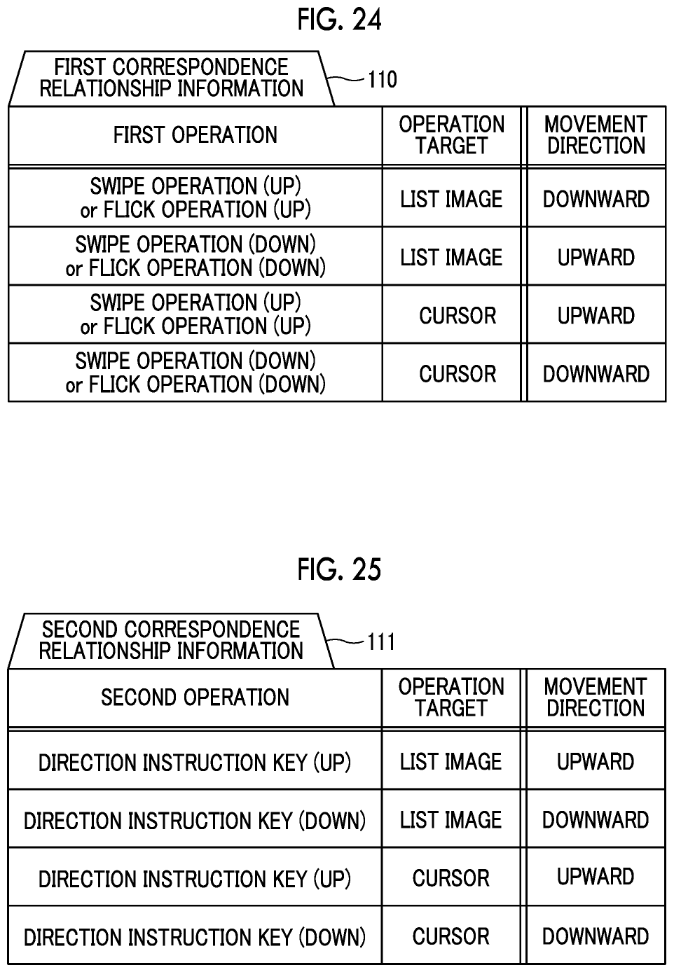

In a third embodiment shown in FIGS. 24 to 30, the operation target is both the list image 35 and the cursor 37.

In this case, as shown in FIG. 24, a direction of the swipe operation or the flick operation and movement directions of the list image 35 and cursor 37 which are the operation targets are registered as the first correspondence relationship in first correspondence relationship information 110. As shown in FIG. 25, a direction of operation of the direction instruction key 22 and the movement directions of the list image 35 and the cursor 37 are registered as the second correspondence relationship in second correspondence relationship information 111. The first correspondence relationship information 110 is a combination of the first correspondence relationship information 72 shown in FIG. 11 of the first embodiment and the first correspondence relationship information 101 shown in FIG. 20 of the second embodiment. Similarly, the second correspondence relationship information 111 is a combination of the second correspondence relationship information 73 shown in FIG. 12 of the first embodiment and the second correspondence relationship information 102 shown in FIG. 21 of the second embodiment.

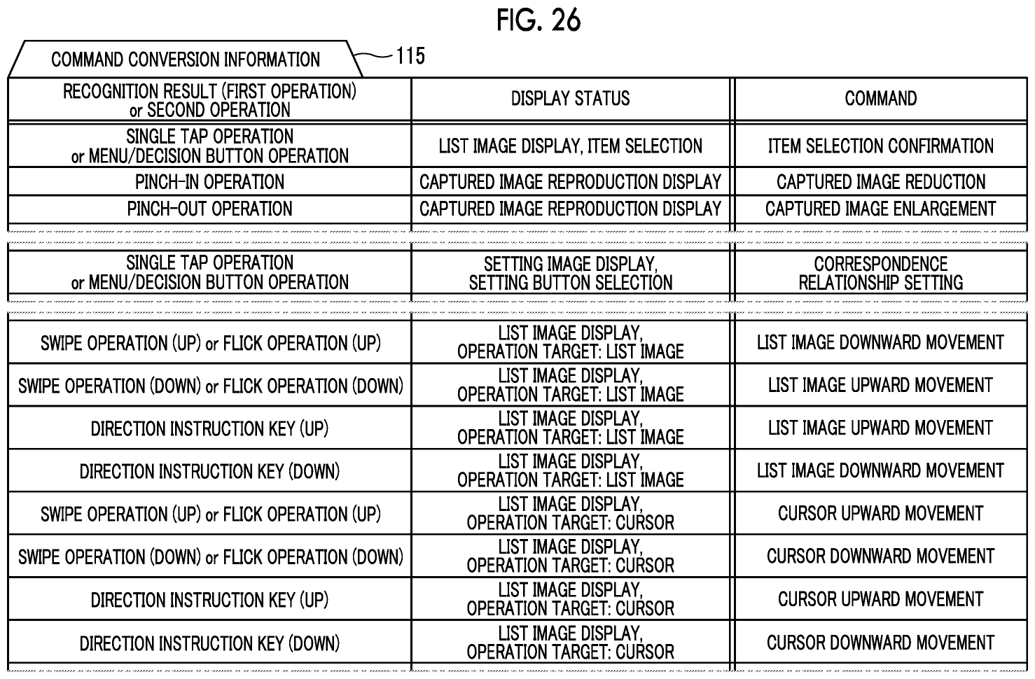

A command conversion information 115 generated by the information management unit 84 based on the first correspondence relationship information 110 and the second correspondence relationship information 111 is as shown in FIG. 26. As described above, the information management unit 84 sets the first correspondence relationship and the second correspondence relationship for each operation target.

In the present embodiment, the operation target is switched to any one of the list image 35 or the cursor 37. More specifically, in a case where the cursor 37 is moved within a range of the screen 32, the cursor 37 is the operation target. On the contrary, in a case where the cursor 37 is moved to an end of the screen 32 and the first operation or the second operation is further performed in a direction where the cursor 37 is moved out of the range of the screen 32, the operation target is changed to the list image 35.

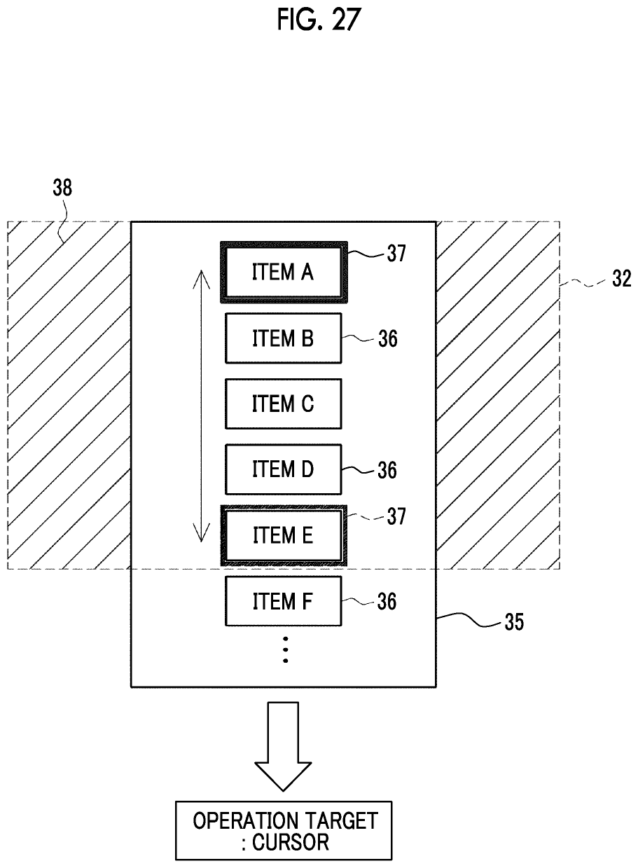

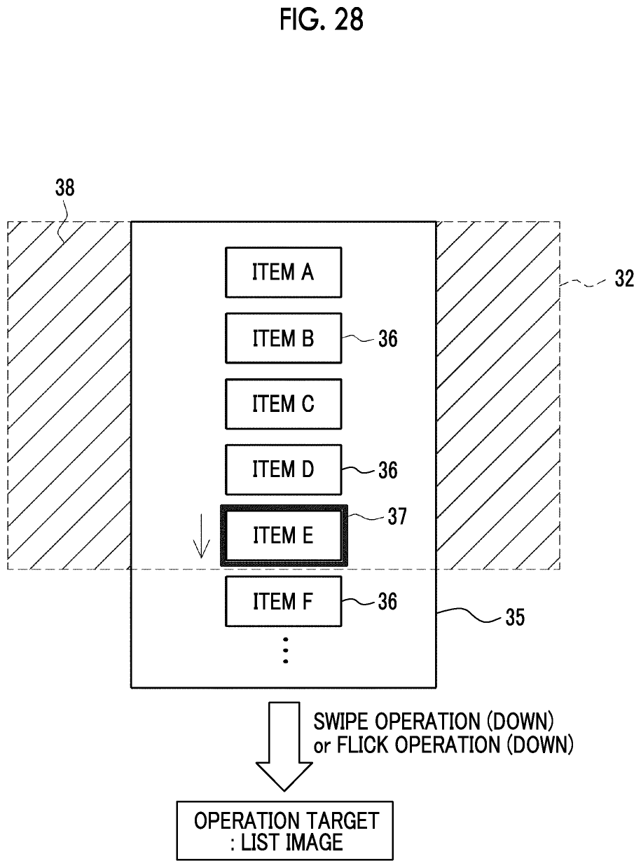

For example, in a case where the cursor 37 is moved within a range of the items A to E in a state where the items A to E of the list image 35 are displayed on the screen 32 as shown in FIG. 27, the cursor 37 is the operation target. On the other hand, for example, in a case where the cursor 37 is moved to the item E at an end of the screen 32 by the downward swipe operation or flick operation and the downward swipe operation or flick operation is further performed as shown in FIG. 28, the operation target is changed to the list image 35.

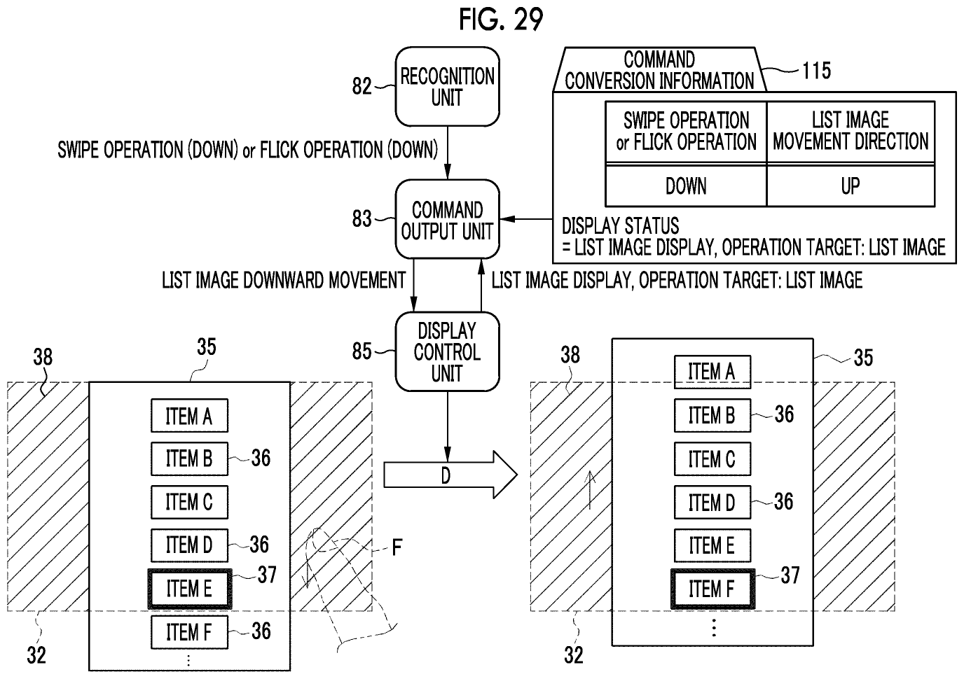

In the first correspondence relationship information 110 shown in FIG. 24, the movement direction of the list image 35 is registered to up for the downward swipe operation or flick operation. Therefore, after the operation target is changed to the list image 35, the list image 35 is moved upward while the display of the cursor 37 is fixed at a lower end of the screen 32 as shown on the right side of an arrow D in FIG. 29, for example. The same display state as in FIG. 28 is shown on the left side of the arrow D in FIG. 29.

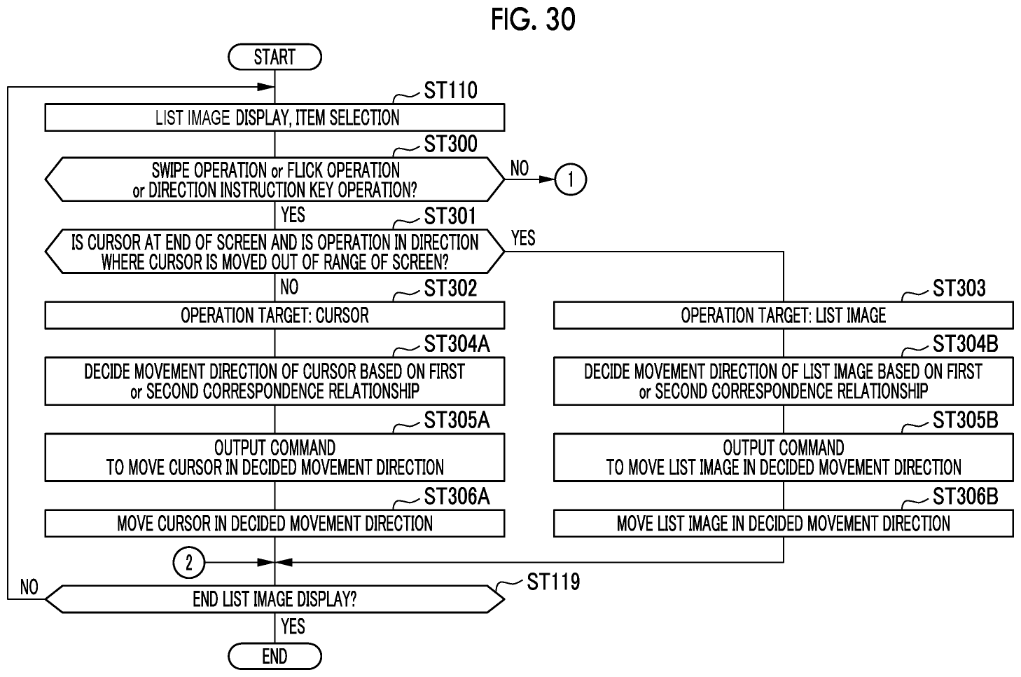

FIG. 30 shows a flowchart according to the present embodiment. In a case where the swipe operation or flick operation or the operation of the direction instruction key 22 is performed (YES in step ST300, NO in step ST301) in a state where the cursor 37 is not moved to the end of the screen 32 in the display status where the item 36 is selected in the list image 35 (step ST110), the operation target is the cursor 37 (step ST302). On the other hand, in a case where the cursor 37 is moved to the end of the screen 32 and the swipe operation or flick operation or the operation of the direction instruction key 22 is further performed in the direction where the cursor 37 is moved out of the range of the screen 32 (YES in both steps ST300 and ST301), the operation target is changed to the list image 35 (step ST303).

Then, the movement direction of the cursor 37 or the list image 35 with respect to the screen 32 is decided based on the first correspondence relationship information 110 in the case of the swipe operation or the flick operation and the second correspondence relationship information 111 in the case of the operation of the direction instruction key 22 (steps ST304A and ST304B, deciding step). Next, a command to move the cursor 37 or the list image 35 in the decided movement direction is output from the command output unit 83 to the display control unit 85 (steps ST305A and ST305B). Finally, the display control unit 85 moves the cursor 37 or the list image 35 in the decided movement direction (steps ST306A and ST306B, display control step).

As described above, the first correspondence relationship and the second correspondence relationship are set for each operation target. Therefore, it is possible to set the first correspondence relationship and the second correspondence relationship more suited to the preference of the user. The operation target is the cursor 37 in the case where the cursor 37 is moved within the range of the screen 32, and the operation target is changed to the list image 35 in the case where the cursor 37 is moved to the end of the screen 32 and the first operation or the second operation is further performed in the direction where the cursor 37 is moved out of the range of the screen 32. Therefore, it is possible to automatically switch the operation target according to the display status of the list image 35.

### Fourth Embodiment

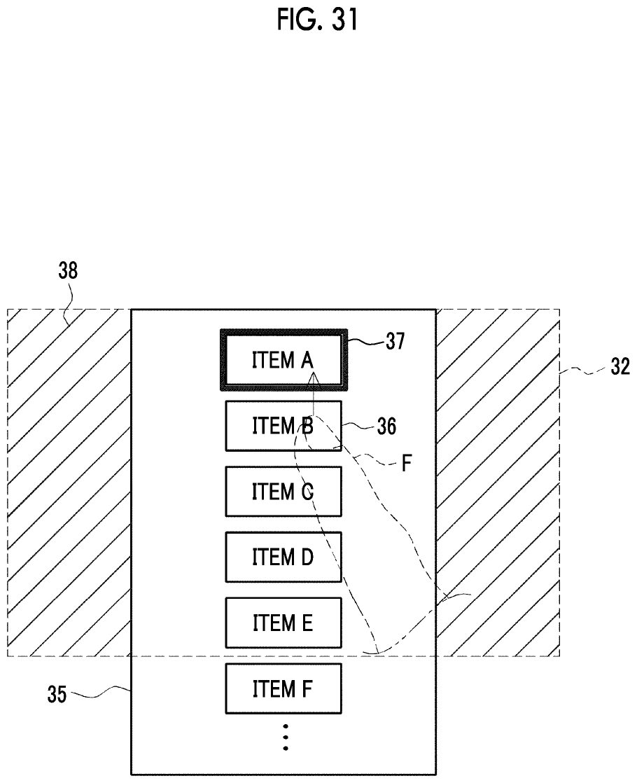

In a fourth embodiment shown in FIGS. 31 to 35, the command for the first operation is changed according to the touch position of the finger F on the touch-type operation unit 31 in the swipe operation or the flick operation. In each of the above embodiments, the touch position of the finger F on the touch-type operation unit 31 is not particularly described. However, in the present embodiment, the command is separated based on the touch position of the finger F on the touch-type operation unit 31. More specifically, a swipe operation or a flick operation on a portion corresponding to the item 36 which is a selection candidate is converted into a command to move (drag) of the item 36 in a direction of the swipe operation or the flick operation. On the other hand, a swipe operation or flick operation on a portion corresponding to the background image 38 is converted into a command to move the list image 35 based on the first correspondence relationship.

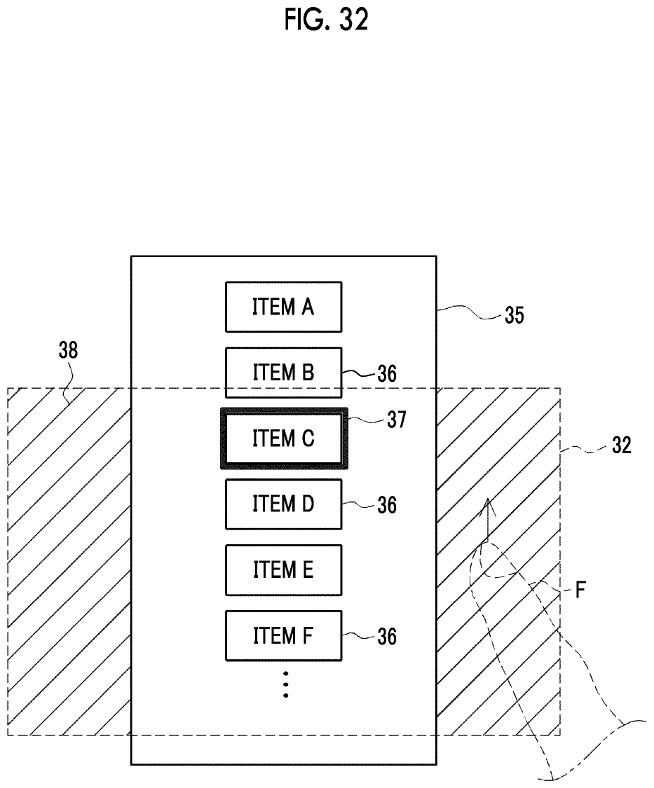

The swipe operation or the flick operation on the portion corresponding to the item 36 is, for example, as shown in FIG. 31. FIG. 31 shows a state where the finger F is in touch with a portion corresponding to the item B and the upward swipe operation or flick operation is performed. On the other hand, the swipe operation or flick operation on the portion corresponding to the background image 38 is, for example, as shown in FIG. 32. FIG. 32 shows a state where the finger F is in touch with the portion corresponding to the background image 38 on the right side of the list image 35 and the upward swipe operation or flick operation is performed.

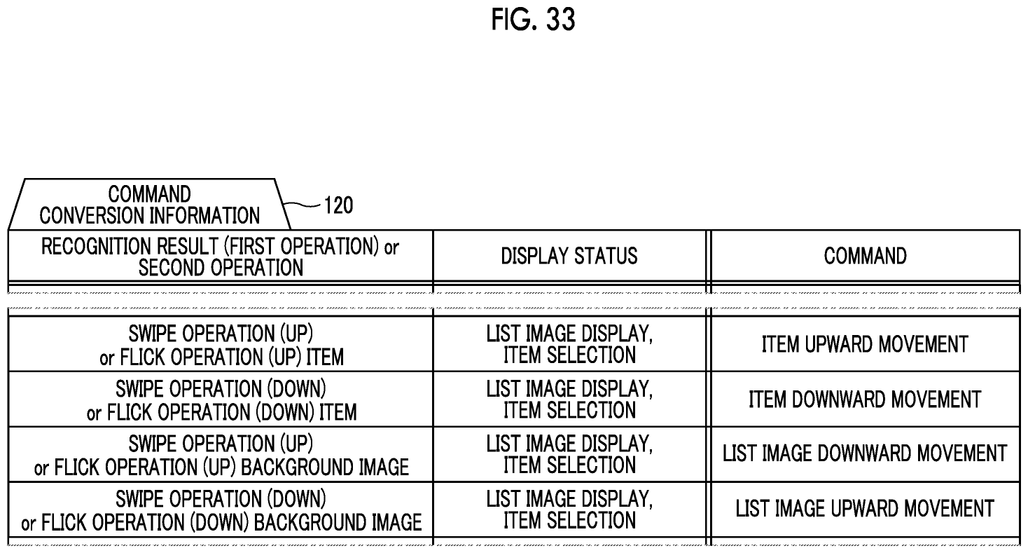

In FIG. 33, different commands are registered in command conversion information 120 according to the present embodiment depending on whether the touch position of the finger F is the item 36 or the background image 38 for the swipe operation or the flick operation. That is, in a case where the touch position of the finger F is the item 36, a command to move the item 36 in the direction of the swipe operation or the flick operation is registered. On the other hand, in a case where the touch position of the finger F is the background image 38, a command to move the list image 35 based on the first correspondence relationship is registered, as in the first embodiment. Here, a command to move the list image 35 downward for the upward swipe operation or flick operation is registered and a command to move the list image 35 upward for the downward swipe operation or flick operation is registered, respectively, similarly to the portion 90A of the command conversion information 71 shown in FIG. 10 of the first embodiment.

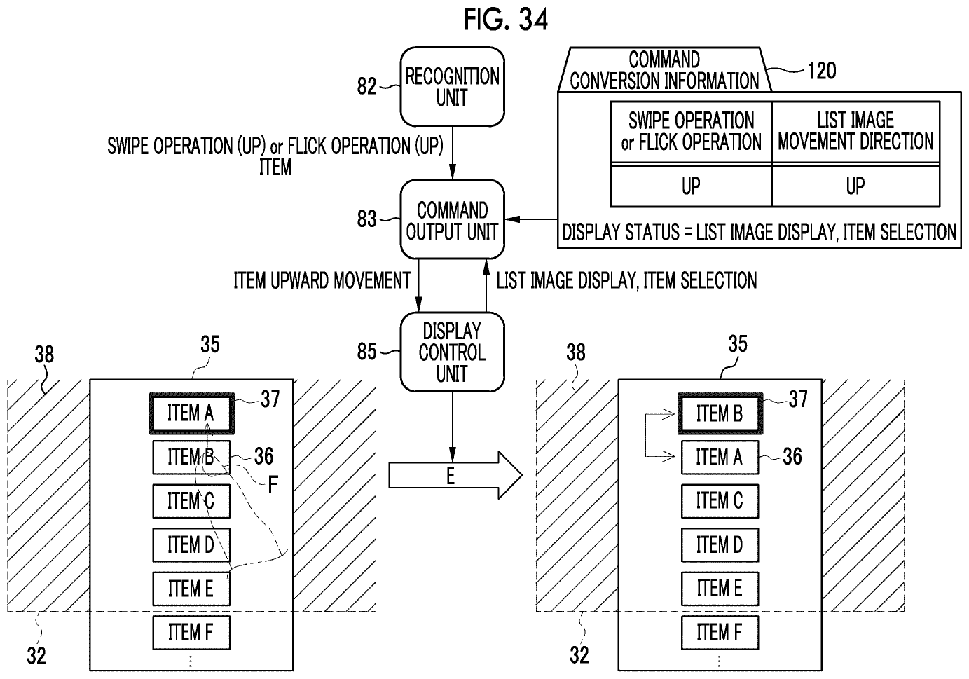

FIG. 34 shows a case where the upward swipe operation or flick operation on the item 36 is performed in the display status where the item 36 is selected in the list image 35. In this case, the command output unit 83 refers to the command conversion information 120 and outputs the command to move the item 36 upward to the display control unit 85. The display control unit 85 moves the item 36 upward in response to the command.

The left side of an arrow E indicates a state where the finger F is in touch with a portion corresponding to the item B and the upward swipe operation or flick operation is performed, as in FIG. 31. In this case, there is a state where the item B is moved upward and the order of the item A and the item B is replaced as shown on the right side of the arrow E. In a case where the swipe operation or flick operation on the background image 38 is performed, there is the same state as the state shown in FIG. 14 of the first embodiment. Therefore, an illustration and a description of the case are omitted.

As described above, the command output unit 83 according to the present embodiment converts the swipe operation or flick operation on the portion corresponding to the item 36 into the command to move the item 36 in the direction of the swipe operation or flick operation, and converts the swipe operation or flick operation on the portion corresponding to the background image 38 into the command to move the list image 35 based on the first correspondence relationship. Therefore, it is possible to clearly separate the swipe operation or flick operation on the item 36 from the swipe operation or flick operation on the background image 38. In the case of the swipe operation or flick operation on the item 36, the display order of the item 36 is replaced accompanying the operation. Therefore, it is possible to customize the item 36, for example, by disposing a frequently used item 36 at the head.

### Fifth Embodiment

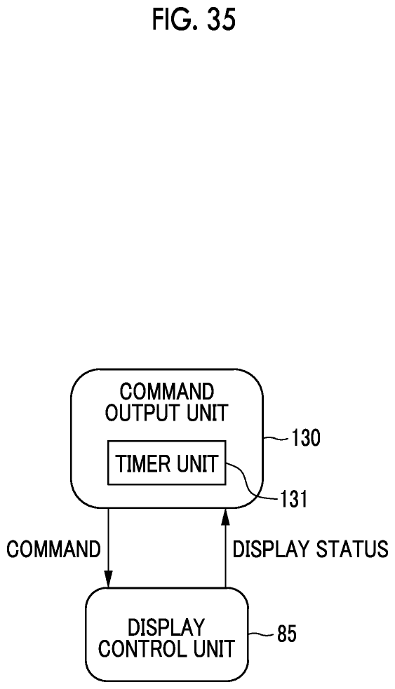

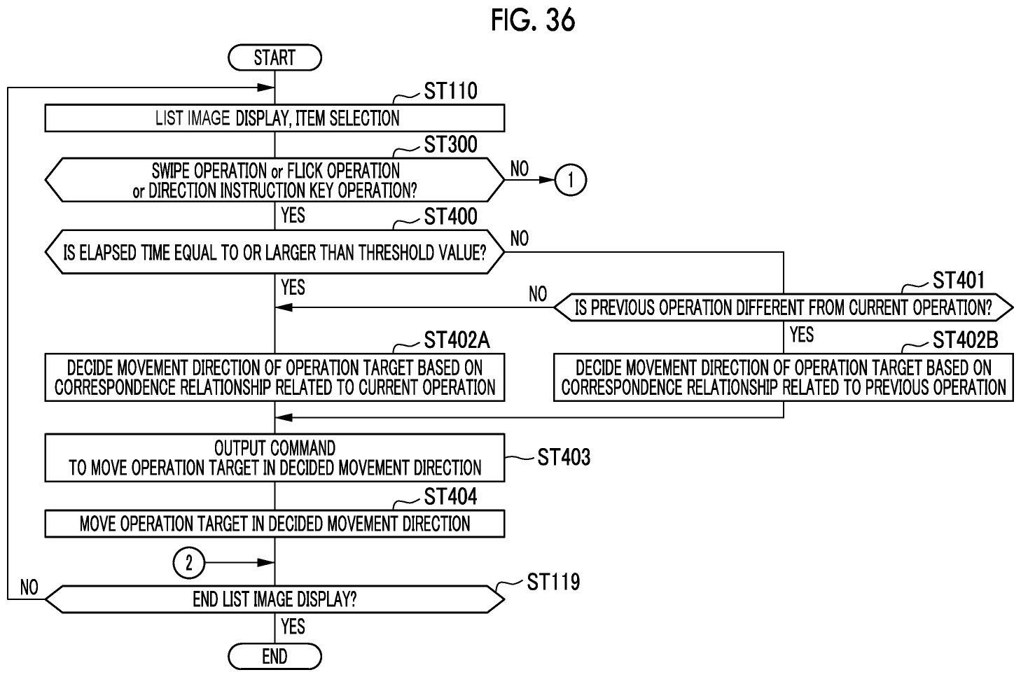

In a fifth embodiment shown in FIGS. 35 and 36, an elapsed time from a previous operation is measured, and a correspondence relationship to be referred to is changed according to the magnitude of the elapsed time and a preset threshold value.

In FIG. 35, a command output unit 130 according to the present embodiment is provided with a timer unit 131. The timer unit 131 measures the elapsed time from a previous swipe operation or flick operation, or a previous operation of the direction instruction key 22. More specifically, the timer unit 131 starts to measure the elapsed time in a case where a command to move the operation target from the command output unit 130 to the display control unit 85 in response to the swipe operation or flick operation, or the operation of the direction instruction key 22.

Further, the timer unit 131 temporarily stores whether the previous operation is the swipe operation or flick operation, or the operation of the direction instruction key 22. In FIG. 35, the illustrations of the first reception unit 80, the second reception unit 81, the recognition unit 82, and the like are omitted.

In this case, as shown in the flowchart of FIG. 36, in a case where the elapsed time is equal to or larger than the threshold value (YES in step ST400), the command output unit 130 decides a movement direction of the operation target with respect to the screen 32 based on a correspondence relationship related on a current operation out of the first correspondence relationship and the second correspondence relationship (step ST402A, deciding step). In a case where the elapsed time is less than the threshold value and both the previous operation and the current operation are the swipe operation or the flick operation, or both the previous operation and the current operation are the operations of the direction instruction key 22 (NO in both steps ST400 and ST401), the movement direction of the operation target with respect to the screen 32 is also decided based on the correspondence relationship related to the current operation.

On the contrary, in a case where the elapsed time is less than the threshold value and the previous operation is the swipe operation or the flick operation and the current operation is the operation of the direction instruction key 22, or the previous operation is the operation of the direction instruction key 22 and the current operation is the swipe operation or the flick operation (NO in step ST400, YES in step ST401), the command output unit 130 decides the movement direction of the operation target with respect to the screen 32 based on a correspondence relationship related on the previous operation out of the first correspondence relationship and the second correspondence relationship (step ST402B, deciding step).

After the movement direction of the operation target is decided, a command to move the operation target in the decided movement direction is output from the command output unit 130 to the display control unit 85 (step ST403). Finally, the display control unit 85 moves the operation target in the decided movement direction (step ST404, display control step).

By doing this, in a case where the first correspondence relationship and the second correspondence relationship are, for example, the first correspondence relationship information 110 and the second correspondence relationship information 111 shown in FIGS. 27 and 28 of the third embodiment and in a case where the operation target is the list image 35 and the upward operation is performed on the direction instruction key 22 in a period less than the threshold value after the upward swipe operation or flick operation is performed, the list image 35 is moved downward according to the first correspondence relationship.

In short, according to the present embodiment, in a case where an interval between the first operation and the second operation is relatively short, which is less than the threshold value, the operation target is moved according to the correspondence relationship related to the previous operation regardless of whether the current operation is the first operation or the second operation. Therefore, even in a case where one of the first operation and the second operation is performed immediately after the other operation, the movement direction of the operation target is not changed from the movement direction of the latest operation. Therefore, the user may not feel uncomfortable. The threshold value is, for example, about three to ten seconds.

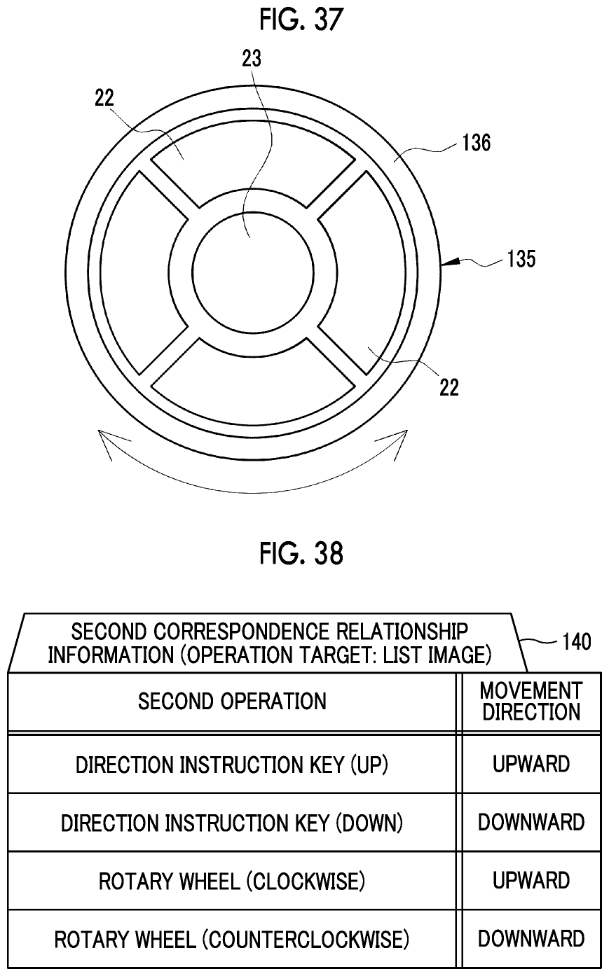

In each of the above embodiments, the direction instruction key 22 is exemplified as the mechanical-type operation unit, but the present invention is not limited thereto. A rotary wheel 136 may be provided in addition to the direction instruction key 22 as in a mechanical-type operation unit group 135 shown in FIG. 37. The rotary wheel 136 is rotationally operated clockwise and counterclockwise as indicated by arrows. In this case, the second correspondence relationship information is, for example, as shown in FIG. 38.

Second correspondence relationship information 140 shown in FIG. 38 is information in which the movement direction of the list image 35 with respect to the operation direction of the rotary wheel 136, in addition to the operation direction of the direction instruction key 22, is registered. That is, the movement direction of the list image 35 is set to up for the clockwise operation of the rotary wheel 136, and the movement direction of the list image 35 is set to down for the counterclockwise operation of the rotary wheel 136.

In each of the above embodiments, only the swipe operation or flick operation in the up-down direction or the up-down operation of the direction instruction key 22 are dealt with, and the operation in a left-right direction is not described. However, of course, the first correspondence relationship and the second correspondence relationship may be set for the left-right direction.

In each of the above embodiments, for example, a hardware structure of a processing unit that executes various types of processing, such as the first reception unit 80 and the second reception unit 81 corresponding to the reception unit, the recognition unit 82, the command output unit 83 corresponding to the deciding unit, the information management unit 84 corresponding to the setting unit, the display control unit 85, and the timer unit 131, is various processors described below.

The various processors include a CPU, a programmable logic device (PLD), a dedicated electric circuit, and the like. The CPU is a general-purpose processor that executes software (program) and functions as various processing units as is well known. The PLD is a processor whose circuit configuration can be changed after manufacturing, such as a field programmable gate array (FPGA). The dedicated circuitry is a processor having a circuit configuration designed specially for executing specific processing, such as an application specific integrated circuit (ASIC).

One processing unit may be composed of one of these various processors or a combination of two or more processors having the same type or different types (for example, combination of a plurality of FPGAs, or CPU and FPGA). A plurality of processing units may be composed of one processor. As an example of composing the plurality of processing units with one processor, first, there is a form in which one processor is composed of a combination of one or more CPUs and software and the processor functions as the plurality of processing units. Second, there is a form of using a processor realizing the functions of the entire system including the plurality of processing units with one IC chip, as represented by a system on chip (SoC) or the like. As described above, the various processing units are composed of one or more of the various processors described above as the hardware structure.

Further, the hardware structure of these various processors is, more specifically, a circuitry combining circuit elements such as a semiconductor element.

From the above description, it is possible to grasp the operation device described in the following additional item 1.

[Additional Item 1]

An operation device including a touch panel display composed of a display unit having a screen for displaying an operation target and a transparent touch-type operation unit disposed on the screen in an overlapped manner and a mechanical-type operation unit provided separately from the touch-type operation unit and having a mechanical structure, the operation device comprising:

a reception processor that receives a setting instruction for a first correspondence relationship which is a correspondence relationship between a direction of a first operation performed on the touch-type operation unit and a movement direction in which the operation target moves with respect to the screen in response to the first operation, and a second correspondence relationship which is a correspondence relationship between a direction of a second operation performed on the mechanical-type operation unit and a movement direction in which the operation target moves with respect to the screen in response to the second operation;

a setting processor that sets the first correspondence relationship and the second correspondence relationship in response to the setting instruction;

a deciding processor that decides a movement direction of the operation target with respect to the screen based on the first correspondence relationship or the second correspondence relationship set by the setting processor in a case where the first operation or the second operation is performed; and a display control processor that moves the operation target in the movement direction decided by the deciding processor.

The selection candidate is not limited to the item 36 in each of the above embodiments. A thumbnail of the captured image may be used as the selection candidate. The operation target is not limited to the list image 35 and the cursor 37. The setting image 40 may be set as the operation target.

In each of the above embodiments, the lens interchangeable type digital camera 10 is exemplified as an example of the imaging device, but the present invention is not limited thereto. The present invention is also adaptable to a digital camera in which a lens portion is provided integrally with a camera body. The present invention is also adaptable to a video camera, a mobile phone with a camera, or the like.

In each of the above embodiments, an example has been described in which the operation device according to the present invention is used for the imaging device. However, the operation device according to the present invention is not limited to the imaging device and may be adaptable to any other electronic device such as a portable game machine or a personal computer.

Needless to say, the invention is not limited to each of the above embodiments, and various configurations may be employed without departing from the gist of the present invention.

### EXPLANATION OF REFERENCES

10: digital camera (imaging device)
11: lens barrel
12: imaging optical system
13: image sensor
14: power lever
15: release switch
16: hot shoe
17: viewfinder part
18: object window
19: eyepiece window
20: touch panel display
21, 135: mechanical-type operation unit group
22: direction instruction key
23: menu/decision button
24: lid
30: display unit
31: touch-type operation unit
32: screen
35,100: list image
36: item
37: cursor
40: setting image
41: radio button
42: setting button
43: cancel button
50: movable lens
51: stop mechanism
55: analog front end (AFE)
56: digital signal processor (DSP)
57: sensor control unit
58: optical system control unit
59: CPU
60: frame memory
61: card control unit
62: storage unit
63: data bus
65: operation program
66: memory card
70: first operation recognition information
71, 105, 115, 120: command conversion information
72, 101, 110: first correspondence relationship information
73, 102, 111, 140: second correspondence relationship information
80, 81: first and second reception units (reception unit)
82: recognition unit
83, 130: command output unit (deciding unit)
84: information management unit (setting unit)
85: display control unit
90A: portion of swipe operation or flick operation in command conversion information
90B: portion of operation of direction instruction key in command conversion information
131: timer unit
F: finger
OA: optical axis
A to E: arrow
ST100 to ST104, ST110 to ST119, ST300 to ST303, ST304A to ST306A, ST304B to ST306B, ST400, ST401, ST402A, ST402B, ST403, ST404: step

What is claimed is:

1. An operation device comprising:
a touch display for displaying an operation; and
an operation member provided separately from the touch display; and
a processor configured to:
receive a setting instruction for a first correspondence relationship which is a correspondence relationship between a direction of a first operation performed on the touch display and a movement direction in which the operation target moves with respect to the touch display in response to the first operation, and a second correspondence relationship which is a correspondence relationship between a direction of a second operation performed on the operation member and a movement direction in which the operation target moves with respect to the touch display in response to the second operation;
set the first correspondence relationship and the second correspondence relationship in response to the setting instruction;
decide the movement direction of the operation target with respect to the touch display based on the set first correspondence relationship or the set second correspondence relationship in a case where the first operation or the second operation is performed;
move the operation target in the decided movement direction; and
measure an elapsed time from a previous first operation or a previous second operation,
wherein the processor executes the movement of the operation target based on a correspondence relationship related to a current operation out of the first correspondence relationship and the second correspondence relationship in a case where the elapsed time is equal to or larger than a preset threshold value, and in a case where the elapsed time is less than the threshold value and both a previous operation and the current operation are the first operation or the second operation, and
executes the movement of the operation target based on a correspondence relationship related to the previous operation out of the first correspondence relationship and the second correspondence relationship in a case where the elapsed time is less than the threshold value and the previous operation is the first operation and the current operation is the second operation or the previous operation is the second operation and the current operation is the first operation.

2. The operation device according to claim 1, wherein the processor sets the first correspondence relationship and the second correspondence relationship for each operation target.

3. The operation device according to claim 2, wherein the operation target includes at least one of a list image in which a plurality of selection candidates are arranged or a cursor for selecting one of the plurality of selection candidates arranged in the list image.

4. The operation device according to claim 3, wherein the cursor becomes the operation target in a case where the cursor moves within a range of the touch display, and the operation target is changed to the list image in a case where the cursor is moved to an end of the touch display and the first operation or the second operation is further performed in a direction where the cursor is moved out of the range of the touch display.

5. The operation device according to claim 1, wherein a list image in which a plurality of selection candidates are arranged on a fixed background image is displayed as the operation target on the touch display, and wherein the processor further configured to:
convert the first operation on a portion corresponding to the selection candidate into a command to move the selection candidate in a direction of the first operation, converts the first operation on a portion corresponding to the background image into a command to move the list image based on the first correspondence relationship, and outputs the commands to perform the display control.

6. The operation device according to claim 1, wherein the first operation includes at least one of a swipe operation in which a finger is brought to touch the touch display, is slowly moved in a certain direction, and then is released from the touch display, or a flick operation in which a finger is brought to touch the touch display and is quickly swept in a certain direction to be released from the touch display.

7. The operation device according to claim 1, wherein the operation member is at least one of a direction instruction key operated in up, down, left, and right directions, or a rotary wheel rotationally operated clockwise and counterclockwise.

8. The operation device according to claim 1, the operation device is used for an imaging device.

9. An operation method of an operation device including a touch display for displaying an operation target and an operation member provided separately from the touch display, the operation method comprising:
a reception step of receiving a setting instruction for a first correspondence relationship which is a correspondence relationship between a direction of a first operation performed on the touch display and a movement direction in which the operation target moves with respect to the touch display in response to the first operation, and a second correspondence relationship which is a correspondence relationship between a direction of a second operation performed on the operation member and a movement direction in which the operation target moves with respect to the touch display in response to the second operation;
a setting step of setting the first correspondence relationship and the second correspondence relationship in response to the setting instruction;
a deciding step of deciding the movement direction of the operation target with respect to the touch display based on the first correspondence relationship or the second correspondence relationship set in the setting step in a case where the first operation or the second operation is performed;
a display control step of moving the operation target in the movement direction decided in the deciding step; and
a measuring step of measuring an elapsed time from a previous first operation or a previous second operation,
wherein the display control step executes the movement of the operation target based on a correspondence relationship related to a current operation out of the first correspondence relationship and the second correspondence relationship in a case where the elapsed time is equal to or larger than a preset threshold value, and in a case where the elapsed time is less than the threshold value and both a previous operation and the current operation are the first operation or the second operation, and
executes the movement of the operation target based on a correspondence relationship related to the previous operation out of the first correspondence relationship and the second correspondence relationship in a case where the elapsed time is less than the threshold value and the previous operation is the first operation and the current operation is the second operation or the previous operation is the second operation and the current operation is the first operation.

10. A non-transitory computer readable medium for storing a computer-executable program for an operation device including a touch display for displaying an operation target and an operation member provided separately from the touch display, the computer-executable program causing a computer to execute the followings:
a reception function of receiving a setting instruction for a first correspondence relationship which is a correspondence relationship between a direction of a first operation performed on the touch display and a movement direction in which the operation target moves with respect to the touch display in response to the first operation, and a second correspondence relationship which is a correspondence relationship between a direction of a second operation performed on the operation member and a movement direction in which the operation target moves with respect to the touch display in response to the second operation;
a setting function of setting the first correspondence relationship and the second correspondence relationship in response to the setting instruction;
a deciding function of deciding the movement direction of the operation target with respect to the touch display based on the first correspondence relationship or the second correspondence relationship set in the setting step in a case where the first operation or the second operation is performed;
a display control function of moving the operation target in the movement direction decided in the deciding step; and
a measuring function of measuring an elapsed time from a previous first operation or a previous second operation,
wherein the display control function executes the movement of the operation target based on a correspondence relationship related to a current operation out of the first correspondence relationship and the second correspondence relationship in a case where the elapsed time is equal to or larger than a preset threshold value, and in a case where the elapsed time is less than the threshold value and both a previous operation and the current operation are the first operation or the second operation, and
executes the movement of the operation target based on a correspondence relationship related to the previous operation out of the first correspondence relationship and the second correspondence relationship in a case where the elapsed time is less than the threshold value and the previous operation is the first operation and the current operation is the second operation or the previous operation is the second operation and the current operation is the first operation.
